(19) United States
(12) Patent Application Publication
(10) Pub. No.: US 2025/0272714 A1
(43) Pub. Date: Aug. 28, 2025

(54) DYNAMIC OFFERS APPLICATION PROGRAMMING INTERFACES

(71) Applicant: Synchrony Bank, Stamford, CT (US)

(72) Inventors: Ravish Kumar, Stamford, CT (US); Daniel Murphy, Stamford, CT (US)

(21) Appl. No.: 19/055,141

(22) Filed: Feb. 17, 2025

Related U.S. Application Data
(60) Provisional application No. 63/558,430, filed on Feb. 27, 2024.

(51) Int. Cl. G06Q 30/0251; G06Q 30/0601

(52) U.S. Cl. CPC G06Q 30/0255; G06Q 30/0611; G06Q 30/0641

(57) ABSTRACT

Systems and methods are provided through which user online interactions are dynamically processed through an application programming interface (API) to identify and present a set of offers according to the user online interactions. In response to an API call to identify offers presentable to a user, the API obtains user interaction data associated with the user and processes this data, a set of available offers, and a set of parameters corresponding to an interface being accessed by the user through a machine learning algorithm to select a set of offers to be presented through the interface. The API continuously monitors user interactions with the set of offers to update the machine learning algorithm in real-time.

### CROSS-REFERENCE TO RELATED APPLICATIONS

The present patent application claims the priority benefit of U.S. Provisional Patent Application 63/558,430 filed Feb. 27, 2024, the disclosures of which are incorporated herein by reference.

### FIELD

The present disclosure relates generally to a framework through which user online interactions are dynamically processed through an application programming interface (API) to identify and present a set of offers according to the user online interactions.

### SUMMARY

Disclosed embodiments provide a framework through which a dynamic offers API is implemented to process, in real-time, requests to select and present a set of offers tailored according to user interactions with different interfaces implemented through different websites or application landing pages associated with a payment instrument service. According to some embodiments, a computer-implemented method is provided. The computer-implemented method comprises receiving an API call to identify one or more offers for rendering through an interface implemented through a landing page associated with a payment instrument service. The API call includes identifying information associated with a user and with an ongoing online session. Further, the API call is submitted during a request to access the landing page. The computer-implemented method further comprises obtaining user interaction data corresponding to interactions with different external online assets by the user. The user interaction data is obtained using the identifying information. The computer-implemented method further comprises identifying a set of available offers. The set of available offers corresponds to different entities associated with the payment instrument service. The computer-implemented method further comprises processing the user interaction data and the set of available offers through a machine learning algorithm to automatically select a set of offers from the set of available offers. The machine learning algorithm is trained using a dataset of historical user interaction data and corresponding offers presented to different users through the interface. The computer-implemented method further comprises transmitting executable instructions that, as a result of being executed by a computing device of the user, cause the computing device to render the set of offers through the interface. The computer-implemented method further comprises monitoring in real-time and through the interface user interaction with the set of offers. The computer-implemented method further comprises updating the machine learning algorithm according to the user interaction with the set of offers.

In some embodiments, the computer-implemented method further comprises identifying a set of rules corresponding to the set of available offers. The set of rules defines different requirements for rendering of different offers from the set of available offers. The computer-implemented method further comprises processing the set of rules with the user interaction data and the set of available offers through the machine learning algorithm to identify the set of offers.

In some embodiments, the identifying information is obtained from a cookie stored on a browser application implemented on the computing device.

In some embodiments, the identifying information includes a user identifier associated with the user and a session identifier corresponding to the ongoing online session. Further, the user interaction data is obtained using the user identifier and the session identifier.

In some embodiments, the computer-implemented method further comprises determining that the identifying information does not include a user identifier. The computer-implemented further comprises generating a cookie that encodes a new user identifier associated with the user. The cookie is used to track ongoing user interactions with the interface and the set of offers.

In some embodiments, the set of offers is categorized according to a set of offer parameters. Further, the set of offers is rendered through the interface according to the set of offer parameters.

In some embodiments, the computer-implemented method further comprises translating the identifying information into an external user identifier associated with the user. The external user identifier corresponds to a user data connectivity platform that obtains the user interaction data from different external sources. The computer-implemented method further comprises transmitting a query to obtain the user interaction data. The query includes the external user identifier. Further, when the query is received by the user data connectivity platform, the user data connectivity platform provides the user interaction data.

In an example, a system comprises one or more processors and memory including instructions that, as a result of being executed by the one or more processors, cause the system to perform the processes described herein. In another example, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 shows an illustrative example of an environment in which a dynamic offers application programming interface (API) processes an API call to present a set of offers through a website implemented by a payment instrument service in accordance with at least one embodiment;

FIG. 2 shows an illustrative example of an environment in which an offer generation system dynamically processes user interaction data, available offers, and any applicable rules corresponding to the presentation of the available offers to select a set of offers presentable to a user through a website provided by the payment instrument service in accordance with at least one embodiment;

FIG. 3 shows an illustrative example of an environment in which one or more offer selection machine learning algorithms are dynamically trained to process available user interaction data, available offers, and corresponding rules to provide a selection of offers presentable to a user in accordance with at least one embodiment;

FIG. 4 shows an illustrative example of a process diagram through which a set of offers are selected for presentation to a user through a website implemented by the payment instrument service and according to user interaction data and applicable rules in accordance with at least one embodiment;

FIG. 5 shows an illustrative example of a process diagram through which a new user identifier and session identifier is persisted in a browser cookie or application storage in response to an API call from a new user in accordance with at least one embodiment;

FIG. 6 shows an illustrative example of a process diagram through which an API call including an existing user identifier and session identifier is processed through a dynamic offers API to dynamically select offers presentable to a user in accordance with at least one embodiment;

FIG. 7 shows an illustrative example of a process diagram through which a new session identifier corresponding to a present website session is persisted in an existing browser cookie or application storage in response to an API call including an existing user identifier and for offers presentable to the existing user in accordance with at least one embodiment;

FIG. 8 shows an illustrative example of an environment through which a set of offers selected based on user interaction data is presented through a landing page associated with a payment instrument service in accordance with at least one embodiment;

FIG. 9 shows an illustrative example of an environment through which a set of offers selected based on user interaction data is categorized and presented according to a set of applicable rules in accordance with at least one embodiment;

FIG. 10 shows an illustrative example of a process for identifying a set of offer parameters and submitting a request to generate a set of offers presentable to a user in response to an API call in accordance with at least one embodiment;

FIG. 11 shows an illustrative example of a process for selecting a set of offers based on user interaction data corresponding to user interactions on a website associated with a payment instrument service and on external websites in accordance with at least one embodiment;

FIG. 12 shows an illustrative example of a process for monitoring user interactions with a presented set of offers to obtain feedback for updating one or more offer selection machine learning algorithms in accordance with at least one embodiment; and

FIG. 13 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework through which a dynamic offers API is implemented to process, in real-time, requests to select and present a set of offers tailored according to user interactions with different websites or application landing pages associated with a payment instrument service.

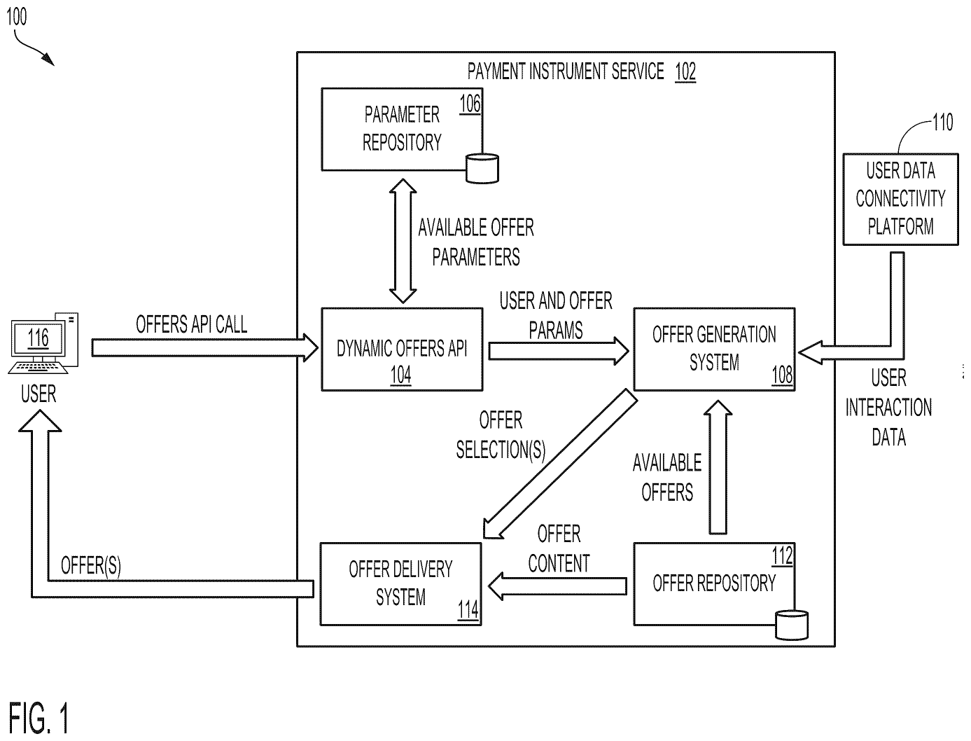

FIG. 1 shows an illustrative example of an environment 100 in which a dynamic offers API 104 processes an API call to present a set of offers through a website or other interface implemented by a payment instrument service 102 in accordance with at least one embodiment. In the environment 100, a user 116, through a browser application or native application executed on a computing device utilized by the user 116, may submit a request to access a website or other landing page associated with a payment instrument service 102. For instance, through a browser application, the user 116 may enter the Uniform Resource Identifier (URI) corresponding to a website provided by the payment instrument service 102. In some examples, if the user 116 has installed, onto their computing device, a native application provided by the payment instrument service 102 for accessing the payment instrument service 102, the native application may automatically transmit a request to the payment instrument service 102 to access a landing page or other interface (such as a graphical user interface (GUI)) provided by the payment instrument service 102. Through the website or other landing page, the payment instrument service 102 may provide the user 116 with one or more interfaces through which the user 116 may dynamically interact with different interface elements provided by the payment instrument service 102, as described in greater detail herein.

The payment instrument service 102, in an embodiment, is a service that processes applications for payment instruments, issues payment instruments, determines user-specific allowances to payment instruments, processes transactions associated with payment instruments, processes cancellations of accounts associated with payment instruments, and performs other such operations. In an embodiment, the payment instrument service 102 further provides an online marketplace, through which different brands and other entities associated with the payment instrument service 102 can present various offers related to different payment instruments and financing options that may be made available to users. Further, through the online marketplace, the different brands and other entities may provide offers related to different goods and/or services provided by these different brands and other entities. In some instances, the different payment instruments and financing options associated with these different brands and other entities, and that may be offered to users, are facilitated by the payment instrument service 102.

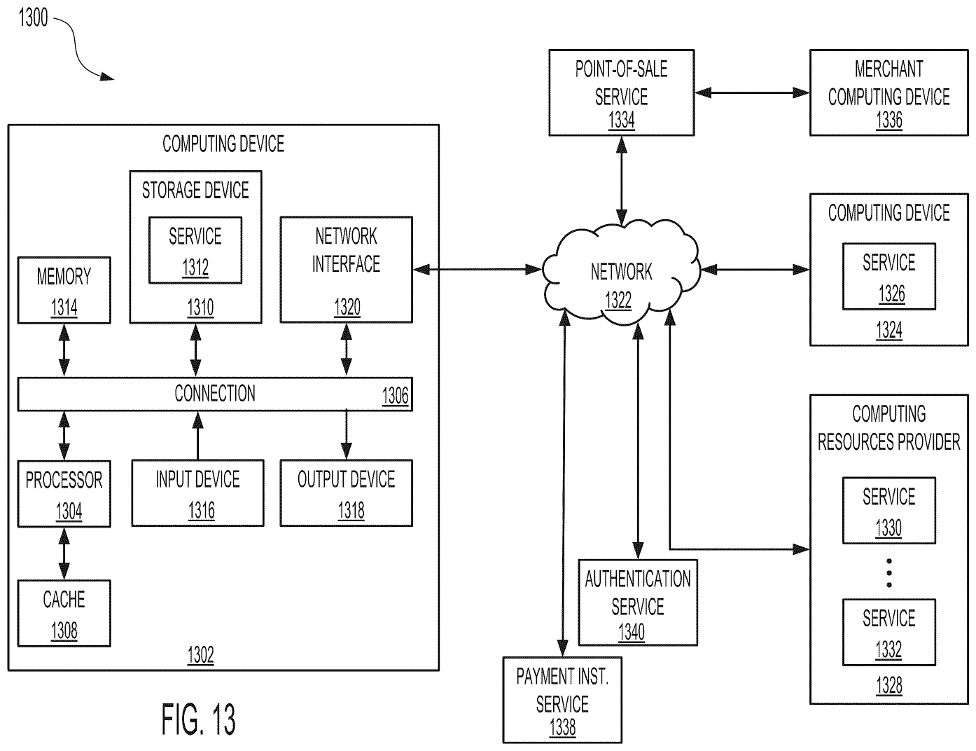

In an embodiment, the payment instrument service 102 is a service such as the service 1312 described herein at least in connection with FIG. 13. In an embodiment, the payment instrument service 102 is a service provided by a merchant. In an embodiment, the payment instrument service 102 is a service provided by a computing resources provider such as the computing resource provide 1328 described herein at least in connection with FIG. 13 (e.g., a service such as service 1330 and/or service 1332 described herein at least in connection with FIG. 13). In an embodiment, the payment instrument service 102 is a payment instrument service such as the payment instrument service 1338 described herein at least in connection with FIG. 13. In some instances, the payment instrument service 102 may be a service operated by the issuer of the payment instruments described herein. In some instances, the payment instrument service 102 may be a service operated by a third-party on behalf of the issuer of the payment instruments described herein.

In an embodiment, the payment instrument service 102 implements and exposes a dynamic offers API 104 through which the user 116 (through their browser application or native application provided by the payment instrument service 102) can submit one or more API calls to identify a set of offers that may be presented to the user 116 through the one or more interfaces provided through the landing page or any other website provided by the payment instrument service 102. When the user 116 submits a request to the payment instrument service 102 to access the website or other landing page associated with the payment instrument service 102, the browser application or native application executed on the user's computing device may automatically, and in real-time, transmit an API call to the dynamic offers API 104 to identify a set of offers that may be presented to the user 116 through the one or more interfaces provided through the website or other landing page. In response to this API call, the dynamic offers API 104 may automatically query a parameter repository 106 implemented by the payment instrument service 102 to identify the available offer parameters used by the payment instrument service 102 to categorize and organize the different offers made available by different brands and other entities for presentation through the one or more interfaces of the website or other landing page associated with the payment instrument service 102. For example, the available offer parameters may include the types of offers made available (e.g., financing offers, discounts, deals, etc.), the offer categories (e.g., décor, automotive, apparel, electronics, health and fitness, home furnishings, etc.), the brands or other entities associated with the payment instrument service 102, and the like. The available offer parameters may further include an indication of whether the payment instrument service 102 provides its own set of offers according to any of the defined offer types and/or categories.

The different parameters included in the parameter repository 106 may be defined by the payment instrument service 102 according to the configuration of the different interfaces implemented through the website and any other landing pages or subsites provided by the payment instrument service 102 and through which different offers may be presented. For example, the initial landing page (i.e., homepage) provided by the payment instrument service 102 may allow for the presentation of a featured set of offers without indication of the type or category of offers being presented. Thus, the parameter repository 106 may indicate, for this initial landing page, that the offer parameters include the brands or other entities associated with the payment instrument service 102 for which offers may be presented. Further, the offer parameters may further include an indication as to whether offers associated with the payment instrument service are available for presentation through the initial landing page. As another illustrative example, if the user 116 navigates to the online marketplace provided by the payment instrument service 102, and through which different offers may be presented according to different types, categories, and brands, the parameter repository 106 may indicate, for the landing page associated with the online marketplace, the various parameters corresponding to these different offer types, offer categories, and brands associated with the available offers presentable through the one or more interfaces of the online marketplace. Thus, the query submitted through the dynamic offers API 104 may provide an indication of the website or other landing page being accessed by the user 116 (e.g., URI, application page indicator, etc.).

In an embodiment, the API call from the user 116 submitted through the dynamic offers API 104 can include identifying information associated with the user 116, as well as identifying information corresponding to an ongoing online session with the payment instrument service 102. For instance, when the user 116 accesses the payment instrument service 102, the API call from the user 116 submitted through the dynamic offers API 104 may include fields corresponding to a user identifier associated with the user 116 and a session identifier associated with an ongoing online session with the payment instrument service 102. These identifiers may be generated by the payment instrument service 102. For instance, if the user 116 is accessing the payment instrument service 102 for the first time, the API call submitted through the dynamic offers API 104 may include null values for these identifiers (e.g., no user identifier or session identifier has been generated for the user 116 and the present online session with the payment instrument service 102). Accordingly, the payment instrument service 102 may automatically generate new user and session identifiers for the user 116 and the ongoing online session between the user 116 and the payment instrument service 102. These new identifiers may be persisted in a browser cookie if the user 116 is accessing the payment instrument service 102 through a browser application executed on their computing device. Alternatively, these new identifiers may be stored in application storage if the user 116 is accessing the payment instrument service 102 through a native application executed on the user's computing device and provided by the payment instrument service 102.

The user identifier and the session identifier may be universally unique identifiers (UUIDs), which may also be referred to as globally unique identifiers (GUID). A UUID may be generated using any suitable technique for generating a unique identifier. A UUID may not be mathematically guaranteed to be unique, but may have a probability of being not unique that is low enough to be considered unique within the context of users associated with the payment instrument service 102 and of online sessions with the payment instrument service 102 by these users. As an example, the UUIDs generated by the payment instrument service 102 may be version 4 UUIDs, which include thirty-two hexadecimal characters representing 128 bits. In one or more embodiments, the bits that comprise the version 4 UUID are randomly generated. Therefore, there are 2¹²⁸ possible combinations of bits, leaving the probability that two such generated UUIDs are the same very low within reasonable time and computation power constraints. A UUID used as the initial identifier may be generated using other techniques for UUID generation. For example, a version 1 UUID is generated based on a Media Access Control (MAC) address of a computing device (or component therein) in combination with an exact time of generation, which would not be duplicated unless the two UUIDs were generated using the same device, having the same MAC address, at the same time. Any other technique for generating a UUID may be used without departing from the scope of embodiments described herein.

In an embodiment, if the user 116 maintains an existing user identifier in a browser cookie (in the case of a request to access the website or other landing page associated with the payment instrument service 102) or in application storage (in the case of a request to access a landing page through a native application) but does not persist a session identifier corresponding to an existing online session with the payment instrument service 102, the payment instrument service 102 automatically generates a new session identifier corresponding to this new online session with the payment instrument service 102. The payment instrument service 102, through an API response transmitted through the dynamic offers API 104, may persist this new session identifier in the existing browser cookie associated with the user's browser application or application storage associated with the native application.

In an embodiment, the dynamic offers API 104 automatically transmits the user identifier associated with the user 116, the session identifier corresponding to the present online session with the payment instrument service 102, and the identified available offer parameters to an offer generation system 108 for selection of one or more offers that may be presented to the user 116 through the one or more interfaces implemented on the website or native application. The offer generation system 108 may be implemented on a computer system or other system (e.g., server, virtual machine instance, etc.) associated with the payment instrument service 102. Alternatively, the offer generation system 108 may be implemented as an application or other executable process executed on one or more computer systems associated with the payment instrument service 102. In an embodiment, the offer generation system 108 uses the provided user identifier and session identifier to obtain any current and historical interaction data associated with the user 116. For instance, as the user 116 interacts with payment instrument service 102 (e.g., accesses an existing payment instrument account, interacts with the online marketplace, etc.), the offer generation system 108 may automatically monitor and record these interactions within a database, cache, or other repository in association with the user and session identifiers. Thus, the offer generation system 108 may use the provided user identifier and session identifier to query the database, cache, or other repository used to maintain user interaction data to obtain the historical and current user interaction data associated with the user 116.

In an embodiment, if the user 116 has not previously interacted with the payment instrument service 102 (i.e., the user identifier and the session identifier provided through the dynamic offers API 104 are null), the offer generation system 108 can obtain alternative information that may be used to uniquely identify the user 116. For example, the offer generation system 108 may identify the Internet Protocol (IP) address of the user 116 based on the communications between the user 116 and the payment instrument service 102. As another illustrative example, through monitoring of user interactions with the payment instrument service 102, if the user 116 provides any identifying information (e.g., name, electronic mail address, physical address, etc.), the offer generation system 108 may automatically associate this identifying information with the user 116 during the ongoing session with the payment instrument service 102. In some instances, the offer generation system 108 may automatically associate this identifying information with the new user and session identifiers generated by the payment instrument service 102 and for the user 116 and the ongoing online session between the user 116 and the payment instrument service 102. Similarly, if the payment instrument service 102 generated a new session identifier for the new ongoing session between the user 116 and the payment instrument service 102, the offer generation system 108 may automatically associate the user's present interactions with the payment instrument service 102 with this session identifier through the database, cache, or other repository.

In an embodiment, the offer generation system 108 queries a user data connectivity platform 110 to obtain any user interaction data associated with the user 116 and corresponding to any external online interactions by the user 116 with other online assets (e.g., websites not associated with the payment instrument service 102, applications not associated with the payment instrument service 102, electronic mail services, social media platforms, etc.). The user data connectivity platform 110 may be implemented by a third-party entity that is external to the payment instrument service 102. For instance, the user data connectivity platform 110 may serve as a data broker that maintains data associated with different users and from different online platforms. For example, the user data connectivity platform 110 may persist or otherwise store data corresponding to user interactions on other websites (e.g., social media platforms, electronic mail service websites, news organization websites, other online marketplaces, brand websites, etc.). This user interaction data may be obtained through cookies stored on the user's browser application and associated with the different online assets that the user may interact with.

The user data connectivity platform 110 may generate, for each user, a unique identifier that may be used to deterministically associate the user with any user interaction data across these different online platforms and assets and corresponding to the user. This unique identifier may differ from the unique user and session identifiers generated by the payment instrument service 102. However, the unique identifier generated by the user data connectivity platform 110 may be associated with different user information that may be known to the payment instrument service 102 (e.g., personal identifiable information (PII), name, physical address, network address, telephone number(s), etc.). In an embodiment, the offer generation system 108 implements a translation layer through which the offer generation system 108 can query the user data connectivity platform 110 for any available user interaction data using any available user information that may be known to both the payment instrument service 102 and the user data connectivity platform 110. For example, if the request submitted through the dynamic offers API 104 includes a unique user identifier corresponding to the user 116, the offer generation system 108 may use this unique user identifier to obtain any available PII or other user information that may be known to both the payment instrument service 102 and the data connectivity platform 110. Using this known user information, the offer generation system 108 may query the user data connectivity platform 110 to obtain any available user interaction data associated with the user 116. In some instances, if the user 116 is accessing the payment instrument service 102 for the first time (i.e., null values are provided for the unique user identifier and session identifier), the offer generation system 108 may utilize any information gleaned through the API call from the user 116 to query the data connectivity platform 110. For example, through the API call, the offer generation system 108 may determine the IP address or other network address of the user 116, an estimated location of the user 116 (such as through IP geolocation, etc.), and the like. The offer generation system 108 may use this gleaned information in its query to the user data connectivity platform 110 to obtain any available user interaction data associated with the user 116.

By leveraging the user data connectivity platform 110, the offer generation system 108 and, hence, the payment instrument service 102 may efficiently obtain available user interaction data without having to continuously monitor numerous external platforms for this data. This distributed method of obtaining user interaction data reduces the resources required by the payment instrument service 102 to obtain user interaction data for the generation of different offers for the user 116.

In an embodiment, in addition to obtaining any available user interaction data associated with the user 116 from the user data connectivity platform 110, the offer generation system 108 queries an offer repository 112 implemented by the payment instrument service 102 to identify the different offers that are available for presentation through the one or more interfaces implemented through the website or native application. The offer repository 112 may be implemented by the payment instrument service 102 to allow different brands or other entities to provide different offers that may be presented to users accessing the payment instrument service 102. As noted above, these offers may include offers related to different payment instruments and financing options (from the payment instrument service 102, different brands, and other entities) that may be made available to users. Further, these offers may further include offers related to different goods and/or services provided by different brands and other entities. For each offer, the offer repository 112 may maintain any assets (e.g., executable code, images, videos, text, etc.) that may be used to implement the offer through any of the interfaces implemented through the websites and/or native application provided by the payment instrument service 102. Further, for each offer, the offer repository 112 may store metadata corresponding to the offer. This metadata may specify one or more characteristics of the offer. These one or more characteristics may include, for example, the title of the offer, the brand associated with the offer, the type of offer, the category associated with the offer, any expiration dates or time ranges during which the offer is made available, and the like.

In an embodiment, the offer repository 112 further stores, for each offer, any rules defined by the payment instrument service 102 and/or the corresponding brand/other entity for determining the methods in which the offer may be presented to users. For example, a rule may indicate the number of times that an offer is required to be presented within a period of time to users through any of the one or more interfaces implemented through the website or native application provided by the payment instrument service 102. As another illustrative example, a rule may indicate whether the offer is to be prioritized according to its expiration date (e.g., the offer is to be presented at a greater frequency as the expiration date draws nearer, etc.). In another illustrative example, a rule may indicate that an offer may only be presented on particular websites/native application interfaces implemented by the payment instrument service 102. Thus, rules implemented for a particular offer may define the criteria or requirements for presentation of the offer to users.

In some instances, the offer repository 112 may further maintain a set of global rules that may be applicable for all offers made available through the offer repository 112. For instance, the payment instrument service 102 may define a global rule whereby offers generated by the payment instrument service 102 are to be prioritized for certain offer categories and/or types. For example, the payment instrument service 102 may define a global rule whereby offers related to different payment instruments and financing options provided by the payment instrument service 102 may be prioritized over other similar offers from brands or other entities. The global rule may further define the frequency in which such prioritization is to be applied such that offers from brands or other entities are not consistently ignored in favor of the offers provided by the payment instrument service 102. In some instances, a global rule may define any prioritization schemas that may be applied by the offer generation system 108 for determining which offers may be presented to users. A prioritization schema, for example, may indicate that the offer generation system 108 is to prioritize offers that are set to expire within a particular period of time regardless of whether offers are provided by the payment instrument service 102 or by other brands/entities. A prioritization schema, in some instances, may define different weights for each prioritization type (e.g., expiration, payment instrument service versus brand/entity, volume, etc.) such that these weights, along with any other applicable rules, may be applied by the offer generation system 108 for selection of the offers that are to be presented through the website or native application interface.

In an embodiment, the offer generation system 108 implements a machine learning algorithm or artificial intelligence that is dynamically trained to process obtained user interaction data (interactions associated with the payment instrument service 102, interactions identified by the user data connectivity platform 110, etc.), the available offers from the offer repository 112, and any applicable rules to select which offers may be presented to the user 116 through one or more interfaces of the particular website or native application interface the user 116 is accessing. The machine learning algorithm or artificial intelligence, in some instances, may be dynamically trained using supervised learning techniques. For example, a dataset of sample user interaction data, sample selected offers from a set of available offers, and corresponding feedback (e.g., sample interactions with the selected offers, etc.) may be selected for training of the machine learning algorithm or artificial intelligence. The machine learning algorithm or artificial intelligence may be evaluated to determine, based on the input user interaction data supplied to the machine learning algorithm or artificial intelligence from the dataset, whether the machine learning algorithm or artificial intelligence is generating accurate (e.g., desirable) offer selections from available offers for presentation to users based on the parameters of the user interaction data (e.g., interactions with the payment instrument service 102, interactions with external websites and platforms, etc.). The machine learning algorithm or artificial intelligence may further be dynamically trained by soliciting feedback with regard to the any offers selected from the set of available offers and presented based on the input user interaction data. For instance, an administrator of the payment instrument service 102 may review user interaction data for a particular user and the corresponding offers selected from the set of available offers and presented to the user to determine whether the machine learning algorithm or artificial intelligence has provided relevant offers to the user. Annotations made by this administrator to the selected offers (e.g., the output of the machine learning algorithm or artificial intelligence) addressing any inaccuracies may be used to update the dataset for further training of the machine learning algorithm or artificial intelligence.

In some embodiments, the machine learning algorithm or artificial intelligence is further trained to process any available user characteristics garnered through the dynamic offers API 104 in the absence of user interaction data to select which offers may be presented to the user 116 through the one or more interfaces of the particular website or native application interface the user 116 is accessing. In such instances where the user interaction data is not available for a user (e.g., a user is accessing the payment instrument service 102 for the first time, etc.), the machine learning algorithm or artificial intelligence may implement a clustering or classification algorithm that may be trained using unsupervised training techniques. For instance, a dataset of user characteristics (e.g., network addresses, location data, computing device configurations, etc.) and available offers may be analyzed using the clustering or classification algorithm to classify different users and corresponding offers according to a set of different classifications (e.g., offer type preferences, offer category preferences, brand preferences, etc.). For instance, the clustering or classification algorithm may be dynamically trained in real-time by classifying different users and available offers according to one or more vectors of similarity between the sample user characteristics and other clusters of users corresponding to different offer preferences (e.g., offer type preferences, offer category preferences, brand preferences, etc.). Thus, in some embodiments, the offer generation system 108 may perform such clustering and obtain partial matches among other clusters of users to identify a particular cluster, and, from this cluster, determine which offers are to be presented to users. Example clustering algorithms that may be trained using this dataset may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like.

In an embodiment, the offer generation system 108 in real-time determines whether the user 116 is a new user (e.g., the user identifier provided through the API call to the dynamic offers API is null) or an existing user (e.g., a user identifier is obtained from a cookie or application storage implemented on the user's computing device). Additionally, the offer generation system 108 may retrieve from the offer repository 112 data corresponding to the offers that are available for presentation to users and any applicable rules that may influence which offers may be selected for presentation to these users. If the offer generation system 108 determines that the user 116 is a new user for which user interaction data is unavailable, the offer generation system 108 may process any available user characteristics associated with the user 116 through the clustering or classification algorithm to identify a particular cluster and, from this cluster, identify any available offers that are associated with this cluster. The machine learning algorithm or artificial intelligence may further evaluate these available offers according to any applicable rules to identify which offers may be presented to the user 116. For example, if an applicable rule indicates that offers corresponding to a particular brand are to be prioritized over offers associated with other brands, the machine learning algorithm or artificial intelligence may process the initial selection of offers according to this rule to ensure that at least one offer associated with the brand is selected for presentation to the user 116.

If the offer generation system 108 determines that the user 116 is an existing user for which user interaction data is available, the offer generation system 108 may process the user interaction data from the user data connectivity platform 110 and any user interaction data maintained by the payment instrument service 102 (e.g., data corresponding to user interactions with websites, native application pages or interfaces, etc.), as well as the set of available offers and any applicable rules from the offer repository 112, through the machine learning algorithm or artificial intelligence to identify a set of offers that may be presented to the user 116 through the website or native application.

By implementing distinct machine learning algorithms or artificial intelligence systems according to whether a user is a new user or an existing user, the offer generation system 108 can increase the likelihood of relevant offers being presented to the user through the one or more interfaces of the website or landing page of the native application being accessed. Further, as the offer generation system 108 implements distinct machine learning algorithms or artificial intelligence systems based on the type of user accessing the payment instrument service 102, the amount of processing required by the systems implementing each machine learning algorithm or artificial intelligence is reduced, as none of the machine learning algorithms or artificial intelligence systems are required to process the user characteristics and available user interaction data for all users accessing the payment instrument service 102. Thus, this bifurcation results in increased system efficiency and reduced latency in identifying relevant offers that may be presented to different users as these different users access the one or more interfaces provided through the website or landing page of a native application.

In an embodiment, the offer generation system 108 provides any offer selections to an offer delivery system 114 for presentation to the user 116 through the one or more interfaces provided through the website or native application. The offer delivery system 114 may be implemented on a computer system or other system (e.g., server, virtual machine instance, etc.) associated with the payment instrument service 102. Alternatively, the offer delivery system 114 may be implemented as an application or other executable process executed on one or more computer systems associated with the payment instrument service 102. The offer selections provided to the offer delivery system 114 may include identifiers or other metadata associated with the offers selected by the offer generation system 108 for presentation to the user 116. This may enable the offer delivery system 114 to query the offer repository 112 for any content associated with the selected offers (e.g., HTML code, Cascading Style Sheets (CSS), JavaScript code, applets, images, videos, text, etc.) that may be used to render the offers through the one or more interfaces of the websites and/or native application provided by the payment instrument service 102.

Once the offer delivery system 114 has obtained the requisite assets corresponding to the selected offers, the offer delivery system 114 may transmit these assets to the user's computing device for rendering of the selected offers through the browser application or native application implemented on the user's computing device. These assets may include executable instructions that, when executed by the browser application or native application, may cause the browser application or native application to render these offers according to the pre-defined offer locations on the one or more interfaces implemented by the website or native application landing page, respectively. For instance, if an interface implemented through a website or native application landing page includes a set of inline frames through which offers may be presented to users, the offer delivery system 114 may provide executable instructions that may cause the browser application or native application, respectively, to render the selected offers within these inline frames.

In an embodiment, the payment instrument service 102 monitors, in real-time, any user interactions with the selected offers to obtain any feedback that can be used to dynamically re-train the machine learning algorithm or artificial intelligence implemented by the offer generation system 108 for selecting offers presentable to different users. For instance, if the user 116 selects or otherwise interacts with one or more interface elements associated with a particular offer from those presented through the one or more interfaces implemented on the website or native application landing page, the payment instrument service 102 may use this selection or other interaction with these one or more interface elements as an indication that the user 116 has responded positively to the particular offer. As another illustrative example, if the user 116 selects an interface element corresponding to an option to dismiss a presented offer (e.g., the user 116 is not interested in the presented offer, the presented offer is repetitive, the user 116 has already taken advantage of the offer, etc.), the payment instrument service 102 may use this interaction as an indication that the user 116 has responded negatively to the particular offer. These interactions with the presented offers (such as through interactions with the interface elements associated with these presented offers) may be annotated and used to update the dataset used to dynamically train the machine learning algorithm or artificial intelligence implemented by the offer generation system 108 to select different offers for presentation to different users.

It should be noted that, in an embodiment, the payment instrument service 102 performs this real-time monitoring of user interactions with any presented offers for different users simultaneously and continuously as these different users interact with the offers selected for these different users. This simultaneous and continuous monitoring of interactions associated with different users may allow for dynamic updating of the dataset used to train the machine learning algorithm or artificial intelligence implemented by the offer generation system 108. Consequently, the machine learning algorithms or artificial intelligence systems implemented by the offer generation system 108 may be continuously updated in real-time to improve the accuracy of the machine learning algorithms or artificial intelligence systems in selecting different offers according to each user's unique characteristics and interaction data.

In an embodiment, in addition to monitoring, in real-time, any user interactions with the selected offers, the payment instrument service 102 further records any user interactions with the one or more interfaces implemented through the website or native application in association with the user identifier corresponding to the user 116 and the session identifier corresponding to the present website or native application session. For instance, if the user 116, through an interface implemented through the website or native application, selects an offer to apply for a new payment instrument provided by the payment instrument service 102 on behalf of a particular brand, and the user 116 returns to the website or the original native application landing page without having completed their application, the payment instrument service 102 may record the user's progress through the application, as well as their initial selection of the offer, in association with the user identifier and the session identifier associated with the user 116. This updated user interaction data may be processed through the machine learning algorithm or artificial intelligence implemented by the offer generation system 108, which may result in selection of the offer previously selected by the user 116, which may serve as a reminder to the user 116 to continue their application for the new payment instrument. Further, based on the user's prior interaction with the offer and the application for the new payment instrument, the machine learning algorithm or artificial intelligence may dynamically identify a new set of offers that may be of interest to the user 116 or otherwise relevant to the user's interactions with the payment instrument service 102.

In an embodiment, if the payment instrument service 102 generates a new user identifier and session identifier for the user 116 (e.g., the user 116 is accessing the payment instrument service 102 for the first time, etc.), the payment instrument service 102, through the dynamic offers API 104, generates a cookie or other application data storable in application storage that encodes the newly generated user identifier and session identifier. The payment instrument service 102 may associate the newly generated user identifier and session identifier with any user interactions performed through the one or more interfaces of the website or native application landing page provided by the payment instrument service 102. Further, in some instances, the payment instrument service 102, through the offer generation system 108, may interact with the user data connectivity platform 110 to associate this user interaction data with any external user interaction data associated with the user 116 and maintained by the user data connectivity platform 110. This may facilitate future identification of additional user interaction data that may be processed by the offer generation system 108 (through the machine learning algorithms or artificial intelligence systems) for the selection of different offers that may be of interest to the user 116 and presentable through the website or native application landing page accessed by the user 116. Further, this may reduce the amount of processing required by the payment instrument service 102 to dynamically generate different offers for the user 116, as the offer generation system 108 may not be required to re-process previously obtained user interaction data corresponding to user interactions with interfaces provided by the payment instrument service 102 and from external sources (as previously obtained from the user data connectivity platform 110).

When the user 116 terminates their existing session with the payment instrument service 102, the payment instrument service 102 may automatically expire the session identifier such that any user interaction data associated with the particular session is automatically disassociated from the session identifier. However, this user interaction data may remain associated with the user identifier in the form of historical data that may inform the user's historical preferences and interests. If the user 116 initiates a new session with the payment instrument service 102, the API call from the user 116 through the dynamic offers API 104 to obtain a new set of offers that may be presented to the user 116 may include the user identifier and expired session identifier from the cookie or application storage. The dynamic offers API 104 may automatically determine that the expired session identifier is associated with a terminated session and, accordingly, may replace this value for the expired session identifier with a null value. This null value may serve as an indication that the user 116 has initiated a new session with the payment instrument service 102. Accordingly, the payment instrument service 102 may generate a new session identifier corresponding to the new online session with the payment instrument service 102. The payment instrument service 102, through the dynamic offers API 104, may persist this new session identifier within the cookie or application storage on the user's computing device. Thus, any new user interaction data obtained through the user's interactions with the payment instrument service 102 may be associated with the user identifier and the new session identifier for the duration of this new online session with the payment instrument service 102.

The delineation of user interaction data according to the user identifier and the session identifier may provide additional context that may be used to determine which offers may be selected for the user 116 during an online session with the payment instrument service 102. For example, the user interaction data associated with the user identifier may correspond to all historical user interactions with the payment instrument service 102 over the previous and current online sessions. Alternatively, the user interaction data associated with the session identifier may correspond to the contemporaneous user interactions with the payment instrument service 102 during the present online session. In an embodiment, the machine learning algorithm or artificial intelligence implemented by the offer generation system 108 may automatically weigh this user interaction data such that the user interaction data associated with the session identifier is given greater weight when determining which offers may be presented to the user 116. Returning to an earlier example, whereby the user 116 may have initiated an application for a new payment instrument associated with a particular brand during a present online session, the machine learning algorithm or artificial intelligence may prioritize the offer to apply for this payment instrument ahead of other available offers as it may be desirable for the user 116 to continue their application for the new payment instrument. As another illustrative example, if the user 116, during an ongoing online session with the payment instrument service 102, interacts with one or more landing pages implemented by the payment instrument service 102 on behalf of a particular brand (e.g., an account management page for payment instruments associated with the brand, an online marketplace associated with the brand, etc.), the user interactions through these one or more landing pages during the ongoing online session may be weighed more heavily by the machine learning algorithm or artificial intelligence such that the machine learning algorithm or artificial intelligence may be more likely to select one or more offers associated with the particular brand for presentation to the user 116.

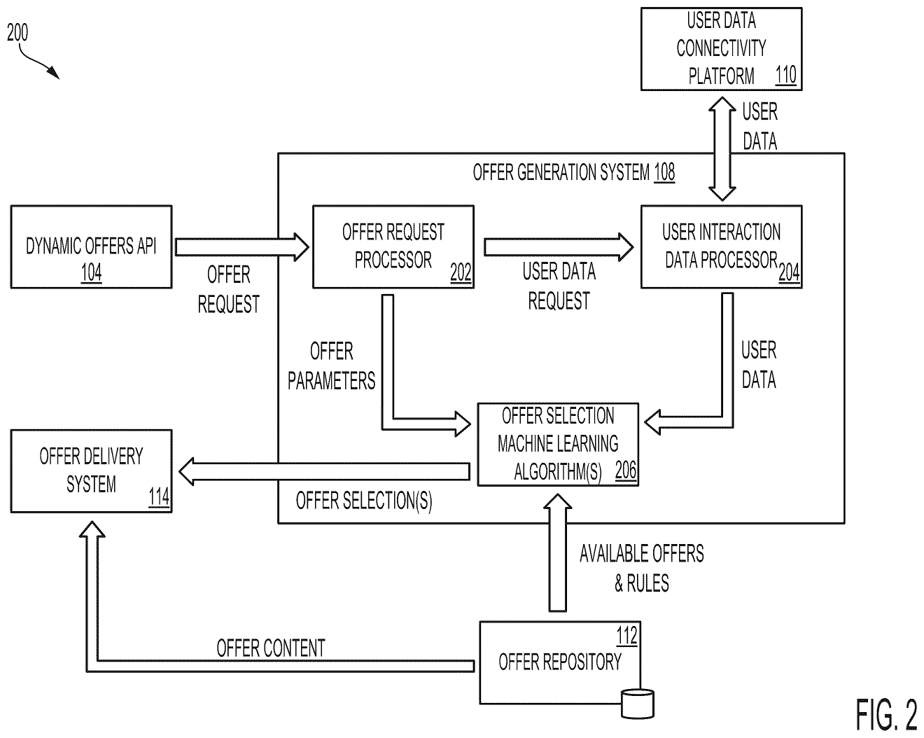

FIG. 2 shows an illustrative example of an environment 200 in which an offer generation system 108 dynamically processes user interaction data, available offers, and any applicable rules corresponding to the presentation of the available offers to select a set of offers presentable to a user through a website provided by the payment instrument service in accordance with at least one embodiment. In the environment 200, the offer generation system 108, through an offer request processor 202, may receive a request from the dynamic offers API 104 for a set of offers that may be presented to a particular user accessing a website or native application landing page associated with the payment instrument service. The offer request processor 202 may be implemented on a computer system or other system (e.g., server, virtual machine instance, etc.) associated with the offer generation system 108. Alternatively, the offer request processor 202 may be implemented as an application or other executable process executed on one or more computer systems associated with the offer generation system 108.

The request provided by the dynamic offers API 104, as noted above, may include a set of offer parameters. These offer parameters may include the types of offers made available by the payment instrument service through one or more interfaces of the particular website or native application landing page (e.g., financing offers, discounts, deals, etc.), the offer categories (e.g., décor, automotive, apparel, electronics, health and fitness, home furnishings, etc.), the brands or other entities associated with the payment instrument service, and the like. The offer parameters may further include an indication of whether the payment instrument service provides its own set of offers according to any of the defined offer types and/or categories. The offer parameters may further indicate information corresponding to the configuration of the one or more interfaces implemented through the website or native application landing page being accessed. For example, the request may indicate the number of offers that may be presented through the one or more interfaces implemented through the website or native application landing page. Further, the request may indicate the characteristics of the website or native application landing page being accessed. For example, the request may indicate if the website or native application landing page is associated with a particular brand. As another illustrative example, the request may indicate if the website or native application landing page is associated with an online marketplace and, if so, the particular category or type selected (if any) for filtering the offers presentable through the website or native application.

The request provided by the dynamic offers API 104 may further include values corresponding to the user identifier and session identifier associated with the user. As noted above, when the user accesses the payment instrument service for the first time, the API call to the dynamic offers API 104 may include null values corresponding to the user identifier and session identifier as the user has not previously interacted with the payment instrument service. Alternatively, if the user has previously interacted with the payment instrument service, the API call to the dynamic offers API 104 may include a value for the user identifier and, if the request is made during an ongoing online session with the payment instrument service, a value for the session identifier. In an embodiment, if the request includes null values for the user and session identifiers, the offer request processor 202 dynamically generates a new user identifier and session identifier for the user. These new identifiers may be provided to the dynamic offers API 104, which may persist these identifiers in a cookie (if access is performed through a browser application) or application storage (if access is performed through a native application provided by the payment instrument service).

In an embodiment, if the user is accessing the payment instrument service for the first time, the offer request processor 202 may obtain, from the dynamic offers API 104 and through the API call submitted by the user, any information that may be used to uniquely identify the user for the present session. For example, through the API call, the offer request processor 202 may determine the IP address or other network address of the user, an estimated location of the user (such as through IP geolocation, etc.), and the like. The offer request processor 202 may associate this information obtained through the API call with the new unique user identifier generated for the user and persisted through the cookie or application storage stored on the user's computing device. If the API call is submitted without a session identifier (i.e., the value corresponding to the session identifier is null), the offer request processor may generate a new session identifier and persist this session identifier in the existing cookie or application storage implemented on the user's computing device.

In response to the API call transmitted through the dynamic offers API 104, the offer request processor 202 may transmit a request to a user interaction data processor 204 implemented by the offer generation system 108 to obtain any external user interaction data corresponding to the user. The user interaction data processor 204 may be implemented on a computer system or other system (e.g., server, virtual machine instance, etc.) associated with the offer generation system 108. Alternatively, the user interaction data processor 204 may be implemented as an application or other executable process executed on one or more computer systems associated with the offer generation system 108. In an embodiment, the user interaction data processor 204, in response to the request from the offer request processor 202, may transmit an API call or other request to an external user data connectivity platform 110 to retrieve any external user interaction data that may be used to determine which offers may be presented to the user. The user interaction data processor 204, in an embodiment, implements a translation layer through which the offer user interaction data processor 204 can query the user data connectivity platform 110 for any available user interaction data using any available user information that may be known to both the payment instrument service and the user data connectivity platform 110. For example, a user data request from the offer request processor 202 includes the unique user identifier associated with the user, the user interaction data processor 204 may use this unique user identifier to obtain any available PII or other user information that may be known to both the payment instrument service and the data connectivity platform 110. The user interaction data processor 204 may use this available information as part of its query to the user data connectivity platform 110 to obtain any available external user interaction data associated with the user. If the user is accessing the payment instrument service for the first time (i.e., null values are provided for the unique user identifier and session identifier), the user interaction data processor 204 may use any information obtained through the API call from the user to query the data connectivity platform 110.

As noted above, the user data connectivity platform 110 may serve as a data broker that maintains data associated with different users and from different online platforms. For example, the user data connectivity platform 110 may persist or otherwise store data corresponding to user interactions on other websites or platforms. This user interaction data may be obtained through cookies stored on the user's browser application and associated with the different online assets that the user may interact with. For each user, the user data connectivity platform 110 may generate a unique identifier that may be used to deterministically associate the user with any user interaction data across these different online platforms and assets and corresponding to the user. This unique identifier may differ from the unique user and session identifiers generated by the offer request processor 202. Through the aforementioned translation layer, the user interaction data processor 204 may transmit to the user data connectivity platform 110, any available PII or other user information associated with the user and maintained by the payment instrument service. This information may be known to both the payment instrument service and the user data connectivity platform 110. Using this known user information, the user data connectivity platform 110 may identify the unique identifier associated with the user (as generated and maintained by the user data connectivity platform 110) and use this unique identifier to retrieve the external user interaction data for the user.

In response to obtaining any available external user interaction data associated with the user, the user interaction data processor 204 may transmit this external user interaction data, as well as any available user interaction data maintained by the payment instrument service (i.e., any user interaction data associated with an existing user identifier and session identifier) and associated with the user, to one or more offer selection machine learning algorithms 206. The one or more offer selection machine learning algorithms 206, in an embodiment, are machine learning algorithms or artificial intelligence systems that are dynamically trained to select a set of offers that may be presented to different users based on these users' interactions with the payment instrument service and any other external entities (e.g., external websites, social media platforms, electronic mail services, etc.). The one or more offer selection machine learning algorithms 206, in an embodiment, include a machine learning algorithm that is dynamically trained using supervised learning techniques. For instance, a dataset of sample user interaction data (e.g., historical user interaction data, hypothetical user interaction data, etc.), sample selected offers from a set of available offers, and corresponding feedback (e.g., sample interactions with the selected offers, etc.) may be selected for training of the one or more offer selection machine learning algorithms 206.

As the one or more offer selection machine learning algorithms 206 generate new outputs corresponding to offers that may be presented to sample users based on the sample user interaction data and available offers, the one or more offer selection machine learning algorithms 206 may be evaluated to determine whether the one or more offer selection machine learning algorithms 206 are making offer selections from the available offers that may be appealing to these sample users. The one or more offer selection machine learning algorithms 206 may further be dynamically trained by soliciting feedback with regard to the offers selected from the set of available offers and presented based on the input user interaction data. For instance, an administrator of the payment instrument service may review user interaction data for a particular user and the corresponding offers selected from the set of available offers and presented to the user to determine whether the one or more offer selection machine learning algorithms 206 have provided relevant offers to the user. Annotations made by this administrator to the selected offers (e.g., the output of the one or more offer selection machine learning algorithms 206) addressing any inaccuracies may be used to update the dataset for further training of the one or more offer selection machine learning algorithms 206.

As noted above, in some instances, the one or more offer selection machine learning algorithms 206 may include a clustering or classification algorithm that is trained to select a set of offers for presentation to a user that is accessing the payment instrument service for the first time. The clustering or classification algorithm implemented through the one or more offer selection machine learning algorithms 206 may process any available user characteristics associated with a first-time user and garnered through the dynamic offers API 104 to identify an initial set of offers that may be presented to the first-time user through the one or more interfaces implemented through the website or native application landing page associated with the payment instrument service. The clustering or classification algorithm may be trained using unsupervised training techniques. As noted above, a dataset of user characteristics (e.g., network addresses, location data, computing device configurations, etc.) and available offers may be analyzed using the clustering or classification algorithm to classify different users and corresponding offers according to a set of different classifications (e.g., offer type preferences, offer category preferences, brand preferences, etc.). These classifications may result in the generation of different clusters corresponding to pairings of user characteristics and different offers. This training may be performed by classifying and clustering different users and available offers according to one or more vectors of similarity between the sample user characteristics and other clusters of users corresponding to different offer preferences (e.g., offer type preferences, offer category preferences, brand preferences, etc.). Thus, in some embodiments, the clustering or classification algorithm associated with the one or more offer selection machine learning algorithms 206 may perform such clustering and obtain partial matches among other clusters of users to identify a particular cluster. From this cluster, the clustering or classification algorithm may determine which offers are to be presented to users.

In an embodiment, in response to obtaining the user interaction data and/or user characteristics associated with a user, the one or more offer selection machine learning algorithms 206 may automatically determine whether the user is a first-time user of the payment instrument service or an existing user for which user interaction data is available. Based on this determination, the one or more offer selection machine learning algorithms 206 may automatically determine whether to utilize the aforementioned clustering/classification algorithm or the machine learning algorithm trained using supervised training techniques. For instance, if the user is a first-time user of the payment instrument service, the one or more offer selection machine learning algorithms 206 may process the obtained user characteristics through the clustering or classification algorithm. Alternatively, if user interaction data associated with the user is provided in the request from the user interaction data processor 204, the one or more offer selection machine learning algorithms 206 may process this user interaction data through the machine learning algorithm trained using the aforementioned supervised training techniques.

The one or more offer selection machine learning algorithms 206, in addition to selection of the particular algorithm to be used for selection of a set of offers for presentation to a user, may query an offer repository 112 to identify which offers are available for presentation, as well as any rules that may be used to refine any initial offer selections to obtain a final set of offers that may be presented to the user. As noted above, the offer repository 112 stores, for each available offer, any rules defined by the payment instrument service and/or the corresponding brand/other entity for determining the methods in which the offer may be presented to users. For instance, a rule may indicate the number of times that an offer is required to be presented within a period of time to users through the website or native application landing page. As another illustrative example, a rule may indicate whether the offer is to be prioritized according to its expiration date (e.g., the offer is to be presented at a greater frequency as the expiration date draws nearer, etc.). In another illustrative example, a rule may indicate that an offer may only be presented on particular websites/native application landing pages.

The offer repository 112 may further maintain a set of global rules that may be applicable to the available offers stored in the offer repository 112. Returning to an earlier illustrative example, the payment instrument service may define a global rule whereby offers associated with goods and/or services provided by the payment instrument service are to be prioritized for certain offer categories and/or types. For instance, the payment instrument service may define a global rule whereby offers related to different payment instruments and financing options provided by the payment instrument service may be prioritized over other similar offers from brands or other entities. The global rule may further define the frequency in which such prioritization is to be applied such that offers from brands or other entities are not consistently disregarded in favor of the offers provided by the payment instrument service. In some instances, a global rule may define any prioritization schemas that may be automatically applied by the one or more offer selection machine learning algorithms 206 for determining which offers may be presented to users. As noted above, a prioritization schema may indicate that the one or more offer selection machine learning algorithms 206 are to prioritize offers that are set to expire within a particular period of time regardless of whether offers are provided by the payment instrument service or by other brands/entities. A prioritization schema, in some instances, may define different weights for each prioritization type (e.g., expiration, payment instrument service versus brand/entity, volume, etc.) such that these weights, along with any other applicable rules, may be applied by the one or more offer selection machine learning algorithms 206 for selection of the offers that are to be presented through the website or native application landing page.

In an embodiment, the one or more offer selection machine learning algorithms 206 process the available user interaction data, user characteristics, available offers, and any applicable rules to select a set of offers that are to be presented to the user through the one or more interfaces implemented on the website or native application landing page. Additionally, the one or more offer selection machine learning algorithms 206 may process any characteristics of the one or more interfaces of the website or native application landing page to determine the number of offers that may be presented or any other configuration information that may be used to further refine the selection of offers. For example, if an interface implemented on the particular website or native application landing page is configured to allow for the presentation of four featured offers, the one or more offer selection machine learning algorithms 206 may process any initial selection of offers for presentation to the user to identify a set of four offers that may be presented through the interface. As another illustrative example, if the interface implemented on the website or native application landing page includes a set of inline frames through which offers may be presented to users, the one or more offer selection machine learning algorithms 206 may select offers that are configured to be presented within the set of inline frames (e.g., the dimensions of the selected offers correspond to the dimensions of the inline frames, etc.).

In an embodiment, the one or more offer selection machine learning algorithms 206 delineate any provided user interaction data according to the user identifier and the session identifier. As noted above, the user interaction data associated with the user identifier may correspond to all historical user interactions with the payment instrument service over the previous and current online sessions. Alternatively, the user interaction data associated with the session identifier may correspond to the contemporaneous user interactions with the payment instrument service during the present online session. The one or more offer selection machine learning algorithms 206, in some instances, may be dynamically trained to differentiate and weigh the user interaction data associated with the session identifier and the complete historical user interaction data associated with the user identifier. Through this weighting of the user interaction data, the one or more offer selection machine learning algorithms 206 may automatically give greater weight to the user interaction data associated with the session identifier when selecting the offers that may be presented to the user. Returning to an earlier example, whereby the user may have initiated an application for a new payment instrument associated with a particular brand during a present online session, the one or more offer selection machine learning algorithms 206 may prioritize the offer to apply for this payment instrument ahead of other available offers as it may be desirable for the user to continue their application for the new payment instrument. As another illustrative example, if the user, during an ongoing online session, interacts with one or more landing pages implemented by the payment instrument service on behalf of a particular brand (e.g., an account management page for payment instruments associated with the brand, an online marketplace associated with the brand, etc.), the user interactions through these one or more landing pages during the ongoing online session may be weighed more heavily by the one or more offer selection machine learning algorithms 206 such that the one or more offer selection machine learning algorithms 206 may be more likely to select one or more offers associated with the particular brand for presentation to the user.

The offer selections generated by the one or more offer selection machine learning algorithms 206 may be provided to the offer delivery system 114 for presentation of the corresponding offers to the user through the one or more interfaces implemented on the website or landing page being accessed by the user. The offer selections may include a set of identifiers or other metadata that may be used to retrieve any assets or other content usable to generate and present the selected offers through the website or native application landing page. The offer delivery system 114 may use the provided set of identifiers or other metadata to query the offer repository 112 for any content associated with the selected offers (e.g., HTML code, CSS, JavaScript code, applets, images, videos, text, etc.) that may be used to render the offers through the interfaces implemented on the websites and/or native application provided by the payment instrument service. Once the offer delivery system 114 has obtained the requisite assets corresponding to the selected offers, the offer delivery system 114 may transmit these assets to the user's computing device for rendering of the selected offers through the browser application or native application implemented on the user's computing device. These assets may include executable instructions that, when executed by the browser application or native application implemented on the user's computing device, may cause the browser application or native application to render these offers according to the pre-defined offer locations on the website or native application landing page, respectively.

In an embodiment, the offer generation system 108 automatically monitors, in real-time, any user interactions with the selected offers to obtain user feedback with regard to these selected offers. This user feedback may be used to dynamically, and in real-time or near real-time, re-train or otherwise update the one or more offer selection machine learning algorithms 206. Returning to an earlier example, if the user selects a particular offer from those presented through the website or native application landing page, the offer generation system 108 may use this selection as an indication that the user has responded positively to the particular offer. Accordingly, the offer generation system 108 may annotate this particular offer to indicate that the user responded positively to the offer and may update the dataset to include this annotation. Processing of the updated dataset may result in reinforcement of the one or more offer selection machine learning algorithms 206 such that, for similar users and user interaction data, the likelihood of this offer being selected may be maintained or increased. Alternatively, if the user selects an option to dismiss a selected offer (e.g., the user is not interested in the selected offer, the selected offer is repetitive, the user has already taken advantage of the selected offer, etc.), the offer generation system 108 may use this action as an indication that the user has responded negatively to the selected offer. The offer generation system 108 may annotate this particular offer to indicate that the user responded negatively to the offer and may update the dataset to include this annotation. Processing of the updated dataset may result in re-training of the one or more offer selection machine learning algorithms 206 such that, for similar users and user interaction data, the likelihood of this offer being selected may be reduced.

As noted above, the real-time monitoring of user interactions with selected offers may be performed for different users accessing the website or native application landing page simultaneously and continuously as these different users interact with the different offers selected for them. This simultaneous and continuous monitoring of interactions with the selected offers presented to different users may allow for dynamic updating of the dataset used to train the one or more offer selection machine learning algorithms 206. Thus, the one or more offer selection machine learning algorithms 206 may be dynamically updated in real-time as different users interact with the different offers selected by the one or more offer selection machine learning algorithms 206 for these different users. This may allow for continuous improvement in the accuracy of the one or more offer selection machine learning algorithms 206 in selecting different offers according to each user's unique characteristics and interaction data.

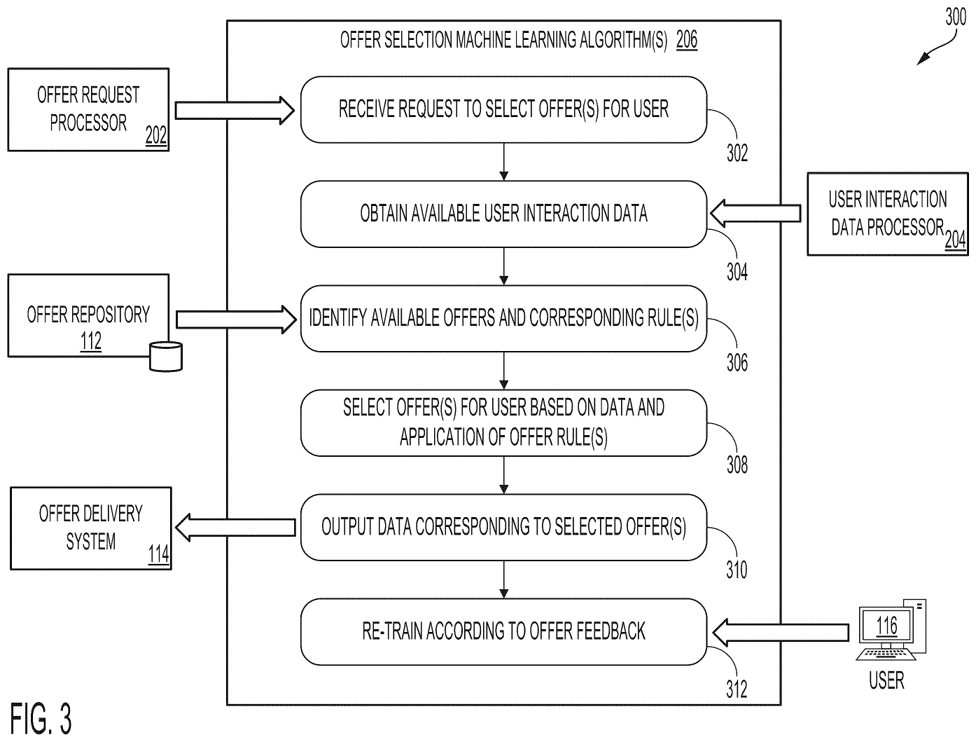

FIG. 3 shows an illustrative example of an environment 300 in which one or more offer selection machine learning algorithms 206 are dynamically trained to process available user interaction data, available offers, and corresponding rules to provide a selection of offers presentable to a user 116 in accordance with at least one embodiment. In the environment 300, the one or more offer selection machine learning algorithms 206, at step 302, may receive a request from the offer request processor 202 to select a set of offers that may be presented to a user 116 through one or more interfaces of a website or native application landing page associated with a payment instrument service. As noted above, the request from the offer request processor 202 may include a set of user characteristics associated with the user 116 to whom a set of offers are being selected. The set of user characteristics may include the network address associated with the user's computing device, any available location data associated with the user 116 (e.g., location data obtained through IP geolocation, location data obtained through Global Positioning System (GPS) peripheral devices, etc.), computing device configurations (e.g., operating system, memory, storage, etc.), and the like. In some instances, if the user 116 has previously interacted with the payment instrument service, the user 116 may maintain, within a cookie or application storage, a user identifier and a session identifier that may be used to identify any historical user interaction data over time and for a current session (if the current session is active). Accordingly, the request from the offer request processor 202 may include the user identifier and the session identifier, if available. As noted above, if the user 116 is accessing the payment instrument service for the first time, the user 116 may not be associated with a user identifier or session identifier. Thus, these identifiers may not be provided if the user 116 is accessing the payment instrument service for the first time.

At step 304, the one or more offer selection machine learning algorithms 206 may obtain, from the user interaction data processor 204, any available user interaction data associated with the user 116. For instance, if the request from the offer request processor 202 includes a session identifier and/or a user identifier associated with the user 116, the one or more offer selection machine learning algorithms 206 may automatically provide the session identifier and/or the user identifier to the user interaction data processor 204 to obtain the available user interaction data. Additionally, or alternatively, the one or more offer selection machine learning algorithms 206 may provide the set of user characteristics provided by the offer request processor 202 to the user interaction data processor 204. In response to receiving the session identifier, the user identifier, and/or the set of user characteristics, the user interaction data processor 204 may query the user data connectivity platform, as described above, to obtain any external user interaction data corresponding to user interactions with other websites not associated with the payment instrument service, applications not associated with the payment instrument service, electronic mail services, social media platforms, and the like. Further, using the session identifier and/or the user identifier (if provided by the one or more offer selection machine learning algorithms 206), the user interaction data processor 204 may obtain any user interaction data corresponding to the user's interactions with the payment instrument service. This user interaction data may be delineated according to when the user interaction data was collected. For instance, the user interaction data processor 204 may distinguish user interaction data collected during a present session with the payment instrument service from other historical user interaction data collected during prior sessions with the payment instrument service. The user interaction data processor 204 may provide the user interaction data associated with the user 116 to the one or more offer selection machine learning algorithms 206 for processing.

It should be noted that, in some instances, the user interaction data processor 204 may automatically provide the user interaction data associated with the user 116 without requiring prompting from the one or more offer selection machine learning algorithms 206. As noted above, the offer request processor 202 may automatically provide the user identifier and the session identifier (if provided through the dynamic offers API) to the user interaction data processor 204. The user interaction data processor 204 may use these identifiers to retrieve any available user interaction data (such as from the user data connectivity platform and from the payment instrument service itself) and provide this user interaction data automatically to the one or more offer selection machine learning algorithms 206 for processing.

At step 306, the one or more offer selection machine learning algorithms 206 may identify, from the offer repository 112, any offers that are available for presentation to users through the website or native application landing page being accessed. Further, from the offer repository 112, the one or more offer selection machine learning algorithms 206 may obtain any rules that may be applicable towards the selection of a set of offers from the available offers maintained in the offer repository 112. As noted above, the offer repository 112 may store offer-specific rules defined by the payment instrument service and/or the corresponding brand/other entity for determining the methods in which the offer may be presented to users. For example, offer-specific rules may indicate the number of times that particular offers are required to be presented within a period of time to users through a website or native application implemented by the payment instrument service. As another illustrative example, offer-specific rules may indicate whether the corresponding offers are to be prioritized according to their expiration date. In another illustrative example, an offer-specific rule may indicate that an offer may only be presented on particular websites/native application landing pages. The offer repository 112 may further maintain a set of global offer rules that may be applicable to all offers made available through the offer repository 112.

At step 308, the one or more offer selection machine learning algorithms 206 may automatically select a set of offers that are to be presented to the user 116 through the website or native application landing page based on the obtained user interaction data, the available offers, and any applicable rules. As noted above, the one or more offer selection machine learning algorithms 206 may determine whether to utilize a clustering/classification algorithm trained using unsupervised training techniques or a machine learning algorithm trained using supervised techniques based on whether the user 116 is accessing the payment instrument service for the first time. For instance, if the user 116 is a first-time user of the payment instrument service, the one or more offer selection machine learning algorithms 206 may process the obtained user characteristics through the clustering or classification algorithm. Alternatively, if user interaction data associated with the user 116 is provided by the user interaction data processor 204, the one or more offer selection machine learning algorithms 206 may process this user interaction data through the machine learning algorithm trained using the aforementioned supervised training techniques. The resulting initial output may include an initial set of offers that may be presentable to the user 116 through the one or more interfaces implemented on the website or native application landing page. In an embodiment, the one or more offer selection machine learning algorithms 206 evaluate this initial set of offers according to any applicable rules (e.g., offer-specific rules and global offer rules) to further refine the initial set of offers. This refinement of the initial set of offers may result in a finalized set of offers that may be presented to the user 116 through the website or native application landing page.

At step 310, the one or more offer selection machine learning algorithms 206 may output data corresponding to this finalized set of offers selected by the one or more offer selection machine learning algorithms 206 to the offer delivery system 114 for presentation of these offers to the user 116 through the one or more interfaces associated with the website or native application landing page accessed by the user 116. As noted above, the one or more offer selection machine learning algorithms 206 may provide a set of identifiers or other metadata associated with the offers selected by the one or more offer selection machine learning algorithms 206 for presentation to the user 116. The offer delivery system 114 may use this set of identifier or other metadata in a query to the offer repository 112 to obtain any content associated with the selected offers (e.g., HTML code, CSS, JavaScript code, applets, images, videos, text, etc.) that may be used to render the selected offers through the one or more interfaces implemented through the website or native application landing page being accessed by the user 116.

At step 312, the one or more offer selection machine learning algorithms 206 are re-trained or otherwise updated according to any user feedback corresponding to the selected offers presented to the user 116 through the website or native application landing page. As noted above, the offer generation system (which implements the one or more offer selection machine learning algorithms 206) may automatically monitor, in real-time, any user interactions with the selected offers to obtain user feedback with regard to these selected offers. Returning to an earlier example, if the user selects a particular offer from those presented through the website or native application landing page, the offer generation system may use this selection as an indication that the user has responded positively to the particular offer. Accordingly, the offer generation system may annotate the pairing of the user interaction data and the selected offer to indicate that the user responded positively to the offer. This annotated data point may be added to the dataset such that when the one or more offer selection machine learning algorithms 206 process the updated dataset, the one or more offer selection machine learning algorithms 206 may be reinforced such that, for similar users and user interaction data, the likelihood of this offer being selected may be maintained or increased. Alternatively, if the user selects an option to dismiss a selected offer (e.g., the user is not interested in the selected offer, the selected offer is repetitive, the user has already taken advantage of the selected offer, etc.), the offer generation system may use this action as an indication that the user has responded negatively to the selected offer. The offer generation system may annotate the pairing of the user interaction data and the selected offer to indicate that the user responded negatively to the offer. The offer generation system may add this annotated data point to the dataset such that when the one or more offer selection machine learning algorithms 206 process the updated dataset, the one or more offer selection machine learning algorithms 206 are re-trained to reduce the likelihood of the offer being selected for similar users and user interaction data.

It should be noted that the steps 302-312 may be automatically performed by the one or more offer selection machine learning algorithms 206 for different users concurrently. For instance, the one or more offer selection machine learning algorithms 206 may automatically process incoming requests from the offer request processor 202 as these requests are received. These requests may correspond to different users and to different websites and/or native application landing pages (and corresponding interfaces) associated with these different users. Thus, the one or more offer selection machine learning algorithms 206 may dynamically, and in real-time, provider offer selections for different users based on their user characteristics and/or user interaction data. Further, as noted above, the real-time monitoring of user interactions with selected offers may be performed for different users accessing different websites or native application landing pages provided by the payment instrument service simultaneously and continuously as these different users interact with the different offers selected for them. This simultaneous and continuous monitoring of interactions with the selected offers presented to different users may allow for dynamic updating of the dataset used to train the one or more offer selection machine learning algorithms 206.

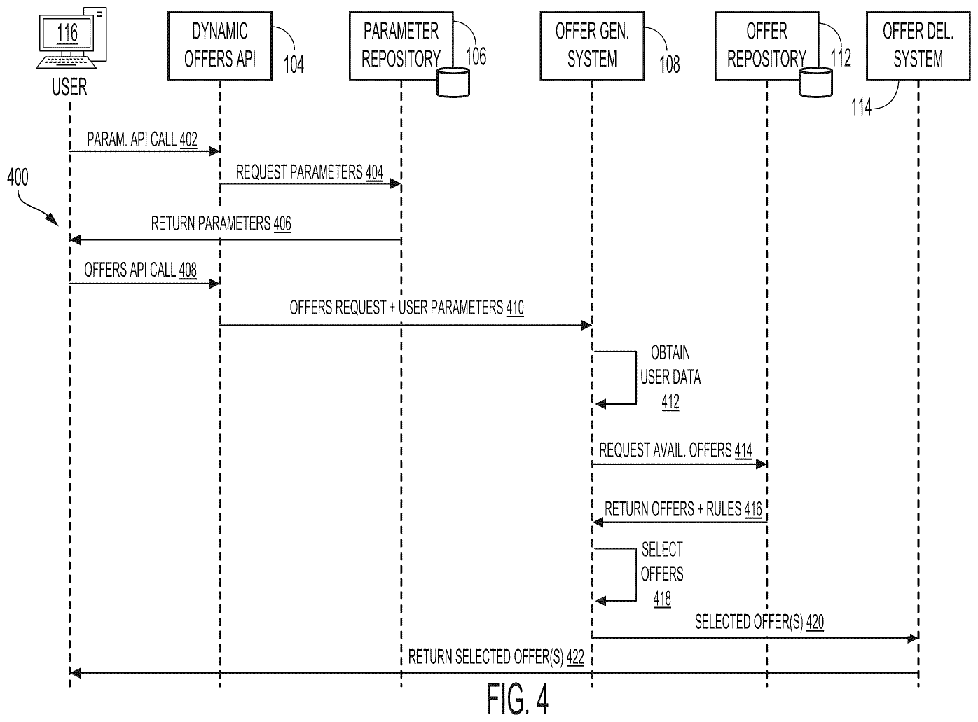

FIG. 4 shows an illustrative example of a process diagram 400 through which a set of offers are selected for presentation to a user 116 through a website implemented by the payment instrument service and according to user interaction data and applicable rules in accordance with at least one embodiment. At step 402 of the process diagram 400, a user 116 (through a browser application or native application provided by the payment instrument service and executed on a computing device) may transmit an offers parameter API call through the dynamic offers API 104. The offers parameter API call may include information corresponding to the website or native application landing page being accessed by the user 116 through the browser application or native application, respectively. For instance, the offers parameter API call may include the network address associated with the website or native application landing page being accessed. Additionally, or alternatively, the offers parameter API call may include configuration information associated with the website or native application landing page being accessed (e.g., Document Object Model (DOM), website or native application landing page documents, interface elements corresponding to interfaces implemented through the website or native application landing page, etc.) and that may be used to discern elements (e.g., inline frames, etc.) through which offers may be presented.

At step 404, the dynamic offers API may transmit a request to the parameter repository 106 to obtain a set of offer parameters for the particular website or native application landing page (including any corresponding interfaces) being accessed. As noted above, the parameter repository 106 may store the available offer parameters used by the payment instrument service to categorize and organize the different offers made available by different brands and other entities for presentation through the website or other native application landing page associated with the payment instrument service. For example, the available offer parameters may include the types of offers made available (e.g., financing offers, discounts, deals, etc.), the offer categories (e.g., décor, automotive, apparel, electronics, health and fitness, home furnishings, etc.), the brands or other entities associated with the payment instrument service, and the like. The available offer parameters may further include an indication of whether the payment instrument service provides its own set of offers according to any of the defined offer types and/or categories. The available offer parameters may be defined by the payment instrument service according to the configuration of the website and any other landing pages or subsites through which different offers may be presented. Returning to an earlier illustrative example, the initial landing page (i.e., homepage) provided by the payment instrument service may allow for the presentation of a featured set of offers without indication of the type or category of offers being presented. Thus, the parameter repository 106 may indicate, at step 406 and for this initial landing page, that the offer parameters include the brands or other entities associated with the payment instrument service for which offers may be presented. Further, the offer parameters may further include an indication as to whether offers associated with the payment instrument service are available for presentation through the initial landing page. As another illustrative example, if the user 116 navigates to the online marketplace provided by the payment instrument service, and through which different offers may be presented according to different offer types, categories, and brands, the parameter repository 106 may indicate, at step 406 and for the landing page associated with the online marketplace, the various parameters corresponding to these different offer types, offer categories, and brands associated with the available offers presentable through the online marketplace.

At step 408, the user 116 (through their browser application or the native application executed on their computing device) may transmit an offers API call to the dynamic offers API 104 to obtain a set of offers that may be presented to the user 116 through the website or native application landing page. The offers API call from the user 116 may include identifying information associated with the user 116, as well as identifying information corresponding to an ongoing online session with the payment service provider. For instance, if the user 116 has previously accessed the payment instrument service, the user 116 (either in a cookie or application storage) may maintain a user identifier and session identifier associated with the user and corresponding to the user's interactions with the payment instrument service. The user identifier may be dynamically generated by the offer generation system 108 when the user 116 accesses the payment instrument service for the first time. Further, when the user 116 initiates a new online session with the payment instrument service, the offer generation system 108 may generate a new session identifier corresponding to this new online session. As described in greater detail herein, as the user interacts with the websites or native application landing pages associated with the payment instrument service (including any corresponding interfaces), the offer generation system 108 may automatically record these user interactions in the form of user interaction data. The offer generation system 108 may dynamically, and in real-time or near real-time, associate this user interaction data with the user identifier and the session identifier. The user interaction data that is associated with the session identifier may be contemporaneous to the particular online session for which the session identifier was generated. Alternatively, the user identifier may be associated with all historical user interaction data corresponding to the user's interactions with the different websites and/or native application landing pages associated with the payment instrument service.

If the user 116 is accessing the payment instrument service for the first time, the offers API call from the user 116 through the dynamic offers API 104 may be devoid of a user identifier and a session identifier, as the user has not previously interacted with the payment instrument service. Alternatively, if the user 116 has previously interacted with the payment instrument service but is otherwise initiating a new online session with the payment instrument service, the offers API call from the user 116 may include the user identifier stored in the cookie or application storage. However, the offers API call in this instance may be devoid of a session identifier, as the user 116 is initiating a new online session with the payment instrument service. In some instances, if the user 116 is resuming an online session with the payment instrument service, the offers API call may include both the user identifier and the session identifier from the cookie or application storage.

The offers API call from the user 116 may further include the offers parameters obtained from the parameter repository, as well as any user characteristics or parameters that may be used to obtain external user interaction data from a user data connectivity platform, as described in greater detail herein. For example, the offers API call from the user 116 may include the IP address or other network address associated with the user's computing device. Further, the offers API call may include identifying information associated with the user 116 (e.g., name, electronic mail address, physical address, etc.). If the user 116 is accessing the payment instrument service for the first time, the offer generation system 108, as described in greater detail herein, may generate a new user identifier and session identifier that may be associated with the user 116. The offer generation system 108 may further associate this identifying information with the newly generated user identifier.

At step 410, the dynamic offers API 104 may transmit a request to the offer generation system 108 to select a set of offers that may be presented to the user 116 through the website or native application landing page being accessed. The request may include the aforementioned offer parameters for the particular website or native application landing page, as well as the user characteristics or parameters provided by the user 116. If the user 116 has previously interacted with the payment instrument service, the offers request may further include the user identifier and the session identifier (if the request is submitted during an ongoing online session) associated with the user 116. If the user 116 is accessing the payment instrument service for the first time, the offer generation system 108 may dynamically generate new user and session identifiers for the user 116 and, through the dynamic offers API 104, persist the new user and session identifiers in a browser cookie or in application storage. Similarly, if the offers request includes a user identifier but is devoid of a session identifier (i.e., the user 116 is initiating a new online session with the payment instrument service), the offer generation system 108 may dynamically generate a new session identifier the user 116 and, through the dynamic offers API 104, persist the new session identifier in the existing browser cookie or application storage.

At step 412, the offer generation system 108 may obtain any available user interaction data associated with the user 116. As noted above, the payment instrument service may maintain user interaction data corresponding to user interactions with the myriad websites and/or native application landing pages implemented by the payment instrument service. This user interaction data may be associated with different user and session identifiers corresponding to different users of the payment instrument service. In an embodiment, if the offers request includes a session identifier and/or a user identifier associated with the user 116, the offer generation system queries a repository or database maintained by the payment instrument service to obtain any user interaction data that may be associated with the session identifier and/or the user identifier. As noted above, the user interaction data associated with a session identifier may be contemporaneous to the particular online session for which the session identifier was generated. Alternatively, the user identifier may be associated with all historical user interaction data corresponding to a user's interactions with the different websites and/or native application landing pages associated with the payment instrument service. If the offers request does not include both the user identifier and the session identifier, the offer generation system 108 may automatically determine that the payment instrument service does not currently maintain any user interaction data associated with the user 116.

In addition to identifying any available user interaction data corresponding to the user 116 and maintained by the payment instrument service, the offer generation system 108 may query a user data connectivity platform or other third-party data broker to obtain any external user interaction data associated with the user 116 and corresponding to any external online interactions by the user 116 with other online assets (e.g., websites not associated with the payment instrument service 102, applications not associated with the payment instrument service 102, electronic mail services, social media platforms, etc.). The user data connectivity platform or other third-party data broker may persist or otherwise store data corresponding to user interactions on other websites (e.g., social media platforms, electronic mail service websites, news organization websites, other online marketplaces, brand websites, etc.). This user interaction data may be obtained through cookies or application storage implemented on the user's computing device and associated with the different online assets that the user may interact with.

As noted above, the user data connectivity platform or other third-party data broker may generate, for each user, a unique identifier that may be used to deterministically associate the user 116 with any user interaction data across these different online platforms and assets and corresponding to the user 116. This unique identifier generated by the user data connectivity platform or other third-party data broker may be associated with different user information that may be known to the payment instrument service (e.g., personal identifiable information (PII), name, physical address, network address, telephone number(s), etc.). The offer generation system 108 may implement a translation layer through which the offer generation system 108 can query the user data connectivity platform or other third-party data broker for any available user interaction data using any available user information that may be known to both the payment instrument service and the user data connectivity platform or other third-party data broker. For instance, if the request submitted through the dynamic offers API 104 includes a unique user identifier corresponding to the user 116, the offer generation system 108 may use this unique user identifier to obtain any available PII or other user information that may be known to both the payment instrument service and the user data connectivity platform or other third-party data broker. Using this known user information, the offer generation system 108 may query the user data connectivity platform or other third-party data broker to obtain any available user interaction data associated with the user 116. If the user 116 is accessing the payment instrument service for the first time, the offer generation system 108 may use the user characteristics or parameters provided in the request to query the user data connectivity platform or other third-party data broker.

At step 414, the offer generation system 108 may query the offer repository 112 to identify the offers that have been made available by different brands and by the payment instrument service and that may be presented to users through the websites and native application landing pages implemented by the payment instrument service. The offers stored in the offer repository 112 may include offers, submitted by different brands and the payment instrument service, related to different payment instruments and financing options that may be made available to users. Further, these offers may further include offers related to different goods and/or services provided by different brands and the payment instrument service. For each offer, the offer repository 112 may maintain any assets (e.g., executable code, images, videos, text, etc.) that may be used to implement the offer through the websites and/or native application landing pages provided by the payment instrument service. Further, for each offer, the offer repository 112 may store metadata corresponding to the offer. This metadata may specify one or more characteristics of the offer (e.g., the title of the offer, the brand associated with the offer, the type of offer, the category associated with the offer, any expiration dates or time ranges during which the offer is made available, etc.).

As noted above, the offer repository 112 may further store offer-specific rules defined by the payment instrument service and/or the corresponding brand/other entity for use in determining the methods in which the offer may be presented to users. For example, offer-specific rules may indicate the number of times that particular offers are required to be presented within a period of time to users through a website or native application implemented by the payment instrument service. As another illustrative example, offer-specific rules may indicate whether the corresponding offers are to be prioritized according to their expiration date. In another illustrative example, an offer-specific rule may indicate that an offer may only be presented on particular websites/native application landing pages. The offer repository 112 may further maintain a set of global offer rules that may be applicable to all offers made available through the offer repository 112. Based on the offer parameters provided by the offer generation system 108 in its query to the offer repository 112, the offer repository 112, at step 416, may return any available offers and corresponding rules associated with these offer parameters.

At step 418, the offer generation system 108 may dynamically process the obtained offers and rules, as well as the available user interaction data (internal to the payment instrument service and as obtained from the user data connectivity platform/third-party data broker) and/or user parameters, to select a set of offers that may be presented to the user 116 through the website or native application landing page being accessed by the user 116. As noted above, the offer generation system 108 may implement one or more offer selection machine learning algorithms that are dynamically trained in real-time to process available user interaction data and/or user parameters, as well as the set of available offers corresponding to the defined offer parameters and any applicable rules, to identify different offers that may be presented to users. The one or more offer selection machine learning algorithms implemented by the offer generation system 108 may automatically differentiate new users (e.g., users that are not associated with both a user identifier and a session identifier) from existing users that have previously interacted with the payment instrument service (e.g., users that are associated with a session identifier and/or a user identifier). If the one or more offer selection machine learning algorithms determine that the user 116 is a new user for which user interaction data is unavailable, the one or more offer selection machine learning algorithms may process any available user characteristics associated with the user 116 through a clustering or classification algorithm to identify a particular cluster and, from this cluster, identify any available offers that are associated with this cluster. These available offers may be evaluated according to any applicable rules and the provided offer parameters to identify which offers may be presented to the user 116.

If the one or more offer selection machine learning algorithms determine that the user 116 is an existing user for which user interaction data is available, the offer generation system 108 may process the user interaction data from the user data connectivity platform or other third-party data broker and any user interaction data maintained by the payment instrument service (e.g., data corresponding to user interactions with websites, native application landing pages or interfaces, etc.), as well as the set of available offers, the offer parameters, and any applicable rules from the offer repository 112, through a machine learning algorithm to identify a set of offers that may be presented to the user 116 through the website or native application landing page.

At step 420, the offer generation system 108 may provide, to the offer delivery system 114, a set of identifiers or metadata corresponding to the offers selected for presentation to the user 116 through the website or native application landing page. In response to receiving this set of identifiers or metadata corresponding to the selected offers, the offer delivery system 114 may query the offer repository 112 to obtain any content or other assets associated with the selected offers (e.g., HTML code, CSS, JavaScript code, applets, images, videos, text, etc.) that may be used to render the offers through the one or more interfaces implemented through the website and/or native application landing page being accessed by the user 116. Once the offer delivery system 114 has obtained the requisite content or other assets corresponding to the selected offers, the offer delivery system 114, at step 422, may transmit this content or other assets to the user's computing device for rendering of the selected offers through the browser application or native application implemented on the user's computing device. The content or other assets may include executable instructions that, when executed by the browser application or native application, may cause the browser application or native application to render these offers according to the pre-defined offer locations on the website or native application landing page, respectively.

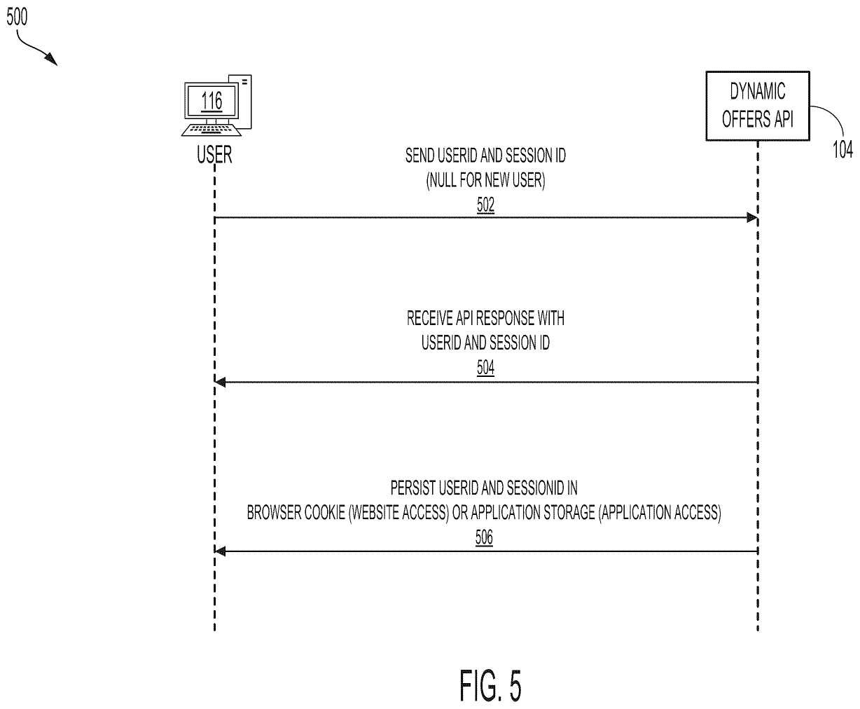

FIG. 5 shows an illustrative example of a process diagram 500 through which a new user identifier and session identifier is persisted in a browser cookie or application storage in response to an API call from a new user 116 in accordance with at least one embodiment. At step 502 of the process diagram 500, a user 116 may transmit an API call to a dynamic offers API 104 to obtain a set of offers that may be presented to the user 116 through a website or native application landing page being accessed by the user 116. As noted above, an offers API call to the dynamic offers API 104 may include a set of fields corresponding to a user identifier associated with the user 116 and a session identifier associated with an ongoing online session with the payment instrument service. As a result of the user 116 accessing the payment instrument service for the first time, the API call submitted through the dynamic offers API 104 may include null values for these identifiers (e.g., no user identifier or session identifier has been generated for the user 116 and the present online session with the payment instrument service).

In response to the API call from the user 116, the offer generation system implemented by the payment instrument service may automatically generate new user and session identifiers for the user 116 and the ongoing online session between the user 116 and the payment instrument service. Further, the dynamic offers API 104, through the offer generation system, may utilize any available external user interaction data (as obtained from a user data connectivity platform or other third-party data broker) to select a set of offers that may be presented to the user 116 through the website or native application landing page being accessed by the user 116. In an embodiment, and at step 504, an offer delivery system implemented by the payment instrument service, and through the dynamic offers API 104, may transmit an API response to the user 116. This API response may include any content or other assets associated with the offers selected by the offer generation system for the user 116. This content or other assets may include executable instructions that, when executed by the browser application or native application implemented on the user's computing device, may cause the browser application or native application to render these offers on the website or native application landing page, respectively. The API response transmitted through the dynamic offers API 104 may further encode the newly generated user identifier and session identifier associated with the user 116.

At step 506, the dynamic offers API 104 may further persist the new user identifier and session identifier in a browser cookie if the user 116 is accessing a website provided by the payment instrument service through a browser application executed on their computing device. Alternatively, if the user 116 is accessing a native application landing page implemented by the payment instrument service through a native application implemented on the user's computing device, the dynamic offers API 104 may persist the newly generated user identifier and session identifier in application storage corresponding to the native application executed on the user's computing device and provided by the payment instrument service.

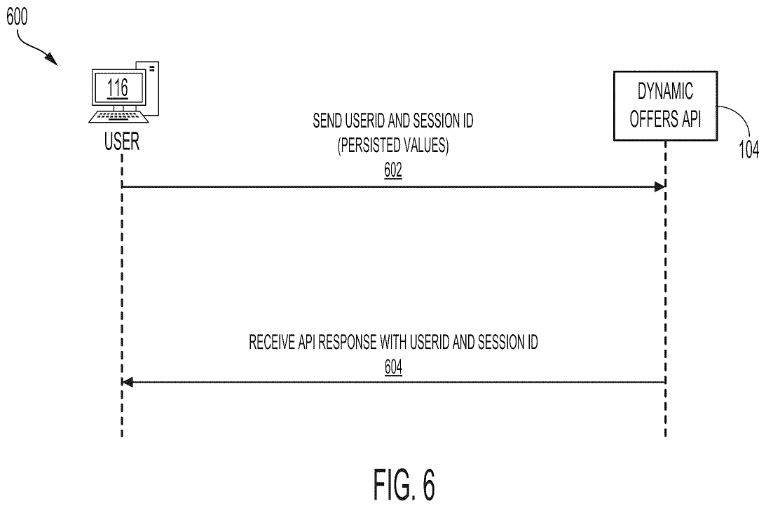

FIG. 6 shows an illustrative example of a process diagram 600 through which an API call including an existing user identifier and session identifier is processed through a dynamic offers API 104 to dynamically select offers presentable to a user 116 in accordance with at least one embodiment. At step 602 of the process diagram 600, a user 116 may transmit an API call to a dynamic offers API 104 to obtain a set of offers that may be presented to the user 116 through a website or native application landing page being accessed by the user 116. As noted above, an offers API call to the dynamic offers API 104 may include a set of fields corresponding to a user identifier associated with the user 116 and a session identifier associated with an ongoing online session with the payment instrument service. As opposed to the process diagram 500 described above in connection with FIG. 5, whereby the user 116 was accessing the payment instrument service for the first time, the user 116 in the process diagram 600 may be accessing the payment instrument service to resume an ongoing session with the payment instrument service. Thus, the offers API call transmitted in step 602 may include a user identifier associated with the user 116 and a session identifier corresponding to the ongoing online session with the payment instrument service.

In response to the offers API call from the user 116, the dynamic offers API 104, through the offer generation system, may use the provided user identifier and session identifier to obtain any available user interaction data associated with the user 116 and corresponding to the user's interactions with the payment instrument service. As noted above, the user interaction data maintained by the payment instrument service for each user may be delineated according to when the user interaction data was collected. For instance, the offer generation system may distinguish user interaction data collected during a current, ongoing session with the payment instrument service from other historical user interaction data collected during prior sessions with the payment instrument service. Thus, the session identifier may be used to identify any user interaction data that is specific to the ongoing online session between the user 116 and the payment instrument service. Further, the user identifier provided through the offers API call may be used to identify any historical user interaction data associated with the user 116 and corresponding to user interactions with the payment instrument service during prior online sessions with the payment instrument service. In addition to obtaining any user interaction data corresponding to the user's interactions with the payment instrument service, the dynamic offers API 104, through the offer generation system, may obtain any available external user interaction data corresponding to user interactions with other external entities (e.g., external websites, social media platforms, electronic mail services, etc.). This available external user interaction data may be obtained through a user data connectivity platform or other third-party data broker, as described in greater detail herein.

As noted above, the offer generation system may process the available user interaction data through one or more offer selection machine learning algorithms that are dynamically trained to select a set of offers that may be presented to a user through the particular website or native application landing page being accessed by the user. Thus, the offer generation system may dynamically process the user interaction data obtained using the user identifier and the session identifier, as well as the external user interaction data associated with the user 116 and obtained from the user data connectivity platform/third-party data broker, to select a set of offers that may be presented to the user 116 through the website or native application landing page being accessed by the user 116. At step 604, the offer delivery system, through the dynamic offers API 104, may transmit an API response to the user 116. This API response may include any content or other assets associated with the offers selected by the offer generation system for the user 116 through the one or more offer selection machine learning algorithms. This content or other assets may include executable instructions that, when executed by the browser application or native application implemented on the user's computing device, may cause the browser application or native application to render these offers through one or more interfaces implemented on the website or native application landing page, respectively. The API response transmitted through the dynamic offers API 104 may further encode the previously generated user identifier and session identifier associated with the user 116 and that was provided in the offers API call to the dynamic offers API 104.

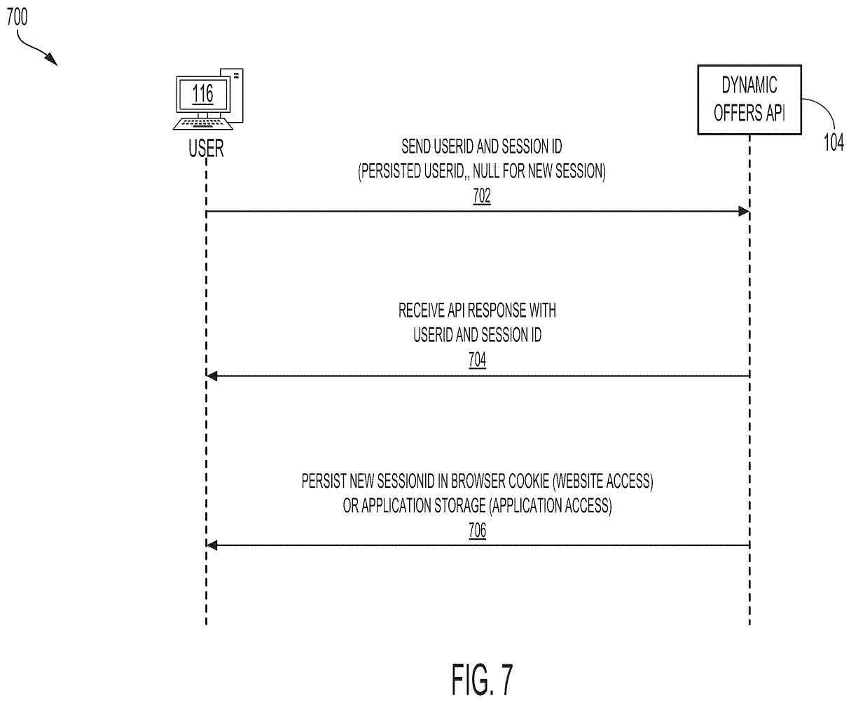

FIG. 7 shows an illustrative example of a process diagram 700 through which a new session identifier corresponding to a present website session is persisted in an existing browser cookie or application storage in response to an API call including an existing user identifier and for offers presentable to the existing user 116 in accordance with at least one embodiment. At step 702 of the process diagram 700, a user 116 may transmit an API call to a dynamic offers API 104 to obtain a set of offers that may be presented to the user 116 through a website or native application landing page being accessed by the user 116. As noted above, an offers API call to the dynamic offers API 104 may include a set of fields corresponding to a user identifier associated with the user 116 and a session identifier associated with an ongoing online session with the payment instrument service. As opposed to the process diagram 500 described above in connection with FIG. 5, whereby the user 116 was accessing the payment instrument service for the first time, the user 116 in the process diagram 700 may have previously accessed the payment instrument service. As such, the user 116 may currently persist (within a browser cookie or application storage) a user identifier generated by the offer generation system of the payment instrument service and that is associated with the user 116. However, unlike the process diagram 600 described above in connection with FIG. 6, the user 116 may be initiating a new online session with the payment instrument service. Thus, the offers API call transmitted in step 702 may include a user identifier associated with the user 116 and may indicate a null value for the session identifier.

In response to the offers API call from the user 116, the offer generation system implemented by the payment instrument service may automatically generate a new session identifiers for the user 116 for the ongoing online session between the user 116 and the payment instrument service. Further, the dynamic offers API 104, through the offer generation system, may use the provided user identifier to obtain any available user interaction data associated with the user 116 and corresponding to the user's interactions with the payment instrument service. As noted above, the user identifier provided through the offers API call may be used to identify any historical user interaction data associated with the user 116 and corresponding to user interactions with the payment instrument service during prior online sessions with the payment instrument service. In addition to obtaining any user interaction data corresponding to the user's interactions with the payment instrument service, the dynamic offers API 104, through the offer generation system, may obtain any available external user interaction data corresponding to user interactions with other external entities (e.g., external websites, social media platforms, electronic mail services, etc.). This available external user interaction data may be obtained through a user data connectivity platform or other third-party data broker, as described in greater detail herein.

Similar to the process diagram 600 described above in connection FIG. 6, the offer generation system may process the available user interaction data through one or more offer selection machine learning algorithms that are dynamically trained to select a set of offers that may be presented to a user through the particular website or native application landing page being accessed by the user. Thus, the offer generation system may dynamically process the user interaction data obtained using the user identifier, as well as the external user interaction data associated with the user 116 and obtained from the user data connectivity platform/third-party data broker, to select a set of offers that may be presented to the user 116 through the website or native application landing page being accessed by the user 116. In an embodiment, and at step 704, an offer delivery system implemented by the payment instrument service, and through the dynamic offers API 104, may transmit an API response to the user 116. This API response may include any content or other assets associated with the offers selected by the offer generation system for the user 116. This content or other assets may include executable instructions that, when executed by the browser application or native application implemented on the user's computing device, may cause the browser application or native application to render these offers on the website or native application landing page, respectively. The API response transmitted through the dynamic offers API 104 may further encode the previously generated user identifier associated with the user 116 as well as the newly generated session identifier associated with the current and ongoing online session with the payment instrument service.

At step 706, the dynamic offers API 104 may further persist the new session identifier in an existing browser cookie if the user 116 is accessing a website provided by the payment instrument service through a browser application executed on their computing device. Alternatively, if the user 116 is accessing a native application landing page implemented by the payment instrument service through a native application implemented on the user's computing device, the dynamic offers API 104 may persist the newly generated session identifier in the application storage corresponding to the native application executed on the user's computing device and provided by the payment instrument service.

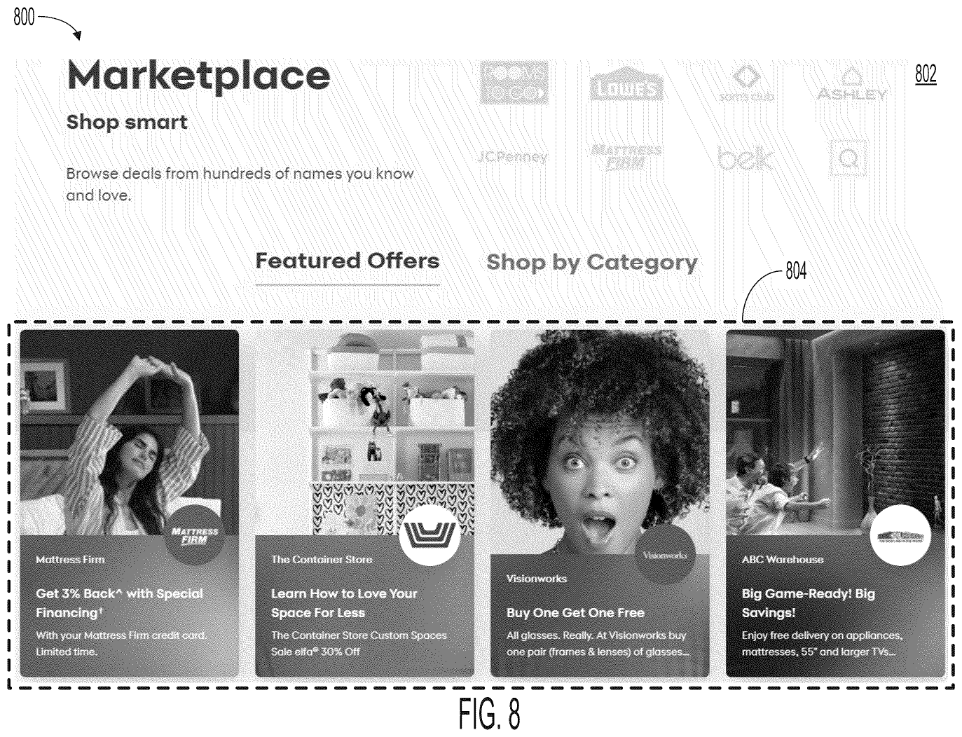

FIG. 8 shows an illustrative example of an environment 800 through which a set of offers 804 selected based on user interaction data is presented through a landing page 802 associated with a payment instrument service in accordance with at least one embodiment. In the environment 800, a user may access a landing page 802 associated with the payment instrument service through a browser application or a native application provided by the payment instrument service. The landing page 802, as illustrated in FIG. 8, may include an interface through which a set of featured offers may be presented to the user and through which the user may interact with these offers. Further, this particular interface implemented through the landing page 802 may be configured to allow for the presentation of four offers that may be selected by an offer generation system of the payment instrument service based on any available user interaction data associated with the user accessing the landing page 802 and/or any user characteristics or parameters associated with the user and obtained when the user accesses the landing page 802.

In an embodiment, when the user accesses the landing page 802, the browser application or native application implemented on the user's computing device may transmit an offers API call through a dynamic offers API implemented by the payment instrument service to obtain a set of assets or other content that may be used to present a set of selected offers 804 through the particular interface of the landing page 802 implemented for the presentation of a set of featured offers. As noted above, if the user is interacting with the payment instrument service for the first time (i.e., the user is accessing the landing page 802 for the first time), the offers API call may be devoid of a user identifier and of a session identifier (e.g., null values are provided for both the user and session identifiers). Alternatively, if the user is accessing the landing page 802 to resume an ongoing online session with the payment instrument service, the offers API call may include, from a browser cookie or application storage, the user identifier associated with the user and the session identifier corresponding to the ongoing online session. These identifiers may be generated by the offer generation system implemented by the payment instrument service, which may persist the identifiers in a browser cookie or application storage. If the user has previously interacted with the payment instrument service but is initiating a new online session with the payment instrument service through the landing page 802, the offers API call to the dynamic offers API may include the user identifier associated with the user and a null value corresponding to the session identifier.

As noted above, the user, through the browser application or native application, may transmit an offers parameter API call through the dynamic offers API. The offers parameter API call may include information corresponding to the landing page 802. For instance, the offers parameter API call may include the network address associated with the landing page 802. Additionally, or alternatively, the offers parameter API call may include configuration information associated with the landing page 802 and the interface implemented through the landing page 802 for the presentation of offers (e.g., DOM, landing page documents, etc.), which may be used to discern elements (e.g., inline frames, etc.) through which offers 804 may be presented. In response to the offers parameter API call, the dynamic offers API may transmit a request to a parameter repository maintained by the payment instrument service to obtain a set of offer parameters for the landing page 802. As noted above, the parameter repository may store the available offer parameters used by the payment instrument service to categorize and organize the different offers made available by different brands and other entities for presentation through different websites or other native application landing pages. The available offer parameters may be defined by the payment instrument service according to the configuration of the websites and any other landing pages or subsites through which different offers may be presented.

As noted above, the landing page 802 provided by the payment instrument service may allow for the presentation of a featured set of offers without indication of the type or category of offers being presented. Thus, the parameter repository may indicate that the offer parameters include the brands or other entities associated with the payment instrument service for which offers may be presented. Further, the offer parameters may further include an indication as to whether offers associated with the payment instrument service are available for presentation through the landing page 802. These identified offer parameters may be returned to the user in response to the offers parameter API call. The user may include the provided offer parameters to the dynamic offers API through the offers API call.

In an embodiment, the offers generation system, using any provided identifiers (e.g., session identifier and/or user identifier) and any user characteristics/parameters associated with the user (network address associated with the user's computing device, any available location data associated with the user, computing device configurations, etc.), may obtain any available user interaction data associated with the user. If the user has previously accessed the payment instrument service, the offers generation system may use the provided session identifier and/or user identifier to identify any user interaction data corresponding to the user's interactions with the payment instrument service. For instance, if the user has provided, through the offers API call, a session identifier and/or user identifier corresponding to the user, the offer generation system may query a repository or database maintained by the payment instrument service to obtain any user interaction data that may be associated with the session identifier and/or the user identifier. As noted above, the user interaction data associated with a session identifier may be contemporaneous to the particular online session for which the session identifier was generated. The user identifier may be associated with all historical user interaction data corresponding to a user's interactions with the different websites and/or native application landing pages associated with the payment instrument service. If the offers request does not include both the user identifier and the session identifier, the offer generation system may automatically determine that the payment instrument service does not currently maintain any user interaction data associated with the user. In addition to obtaining any available user interaction data corresponding to the user's interactions with the payment instrument service, the offer generation system may query a user data connectivity platform or other third-party data broker to obtain any external user interaction data corresponding to user online interactions with other online assets (e.g., websites not associated with the payment instrument service, applications not associated with the payment instrument service, electronic mail services, social media platforms, etc.), as described above.

As noted above, the offer generation system may process the available user interaction data (both internal and external to the payment instrument service), the provided user parameters, and the offer parameters for the landing page 802 through one or more offer selection machine learning algorithms that are dynamically trained to select a set of offers that may be presented to users. The one or more offer selection machine learning algorithms may automatically evaluate a set of available offers according to the provided user data (e.g., user interaction data and user parameters), the offer parameters for the landing page 802, and any applicable rules to select a set of offers for the user. As illustrated in FIG. 8, the interface implemented through the landing page 802 may be configured to accommodate four distinct offers 804. Accordingly, the one or more offer selection machine learning algorithms may dynamically select a set of four offers 804 that may be presented to the user through the interface. As an illustrative example, if the one or more offer selection machine learning algorithms determine, based on the provided user interaction data, that the user is currently shopping for furniture and appliances for a new home, the one or more offer selection machine learning algorithms may be more likely to select a set of offers associated with furniture and appliance brands subject to any applicable rules. As another illustrative example, if the one or more offer selection machine learning algorithms determine, based on an applicable rule, that offers associated with a particular brand must be presented a set number of times within a pre-defined period to different users, and this requirement has not been satisfied, the one or more offer selection machine learning algorithms may prioritize these offers when selecting the set of offers that are to be presented through the interface implemented on the landing page 802.

In an embodiment, once the one or more offer selection machine learning algorithms have dynamically selected a set of offers 804 for presentation to the user through the interface implemented on the landing page 802, the one or more offer selection machine learning algorithms provide a set of identifiers or other metadata associated with the selected set of offers 804 to an offer delivery system of the payment instrument service. The offer delivery system may use these identifiers or metadata to obtain any assets or other content usable to render the selected set of offers 804 through the interface implemented on the landing page 802. Accordingly, when the browser application or native application receives these assets or other content, the browser application or native application may dynamically use the assets or other content to render the set of offers 804 on the landing page 802. This process may be performed in real-time or near real-time such that the set of offers 804 are presented to the user nearly instantaneously when accessing the landing page 802.

In an embodiment, as the user interacts with the set of offers 804 presented through the interface on the landing page 802, the payment instrument service may monitor, in real-time, these interactions to obtain any feedback that can be used to dynamically re-train or otherwise update one or more offer selection machine learning algorithms. For instance, if the user selects a particular offer from the set of offers 804 presented through the landing page 802 (such as through interaction with one or more interface elements rendered through the interface and corresponding to the offer), the payment instrument service may use this selection as an indication that the user has responded positively to the particular offer. As another illustrative example, if the user selects an interface option to dismiss a presented offer (e.g., the user is not interested in the presented offer, the presented offer is repetitive, the user has already taken advantage of the offer, etc.), the payment instrument service may use this action as an indication that the user has responded negatively to the particular offer. These interactions with the presented offers 804 may be annotated and used to update the dataset used to dynamically train the one or more offer selection machine learning algorithms. Thus, as the user navigates the landing page 802 and any other websites/landing pages associated with the payment instrument service, the user's interactions with presented offers may be used to further customize and tailor different offers that may be presented to the user through the landing page 802 and any other websites/landing pages during the present online session and any future online sessions with the payment instrument service.

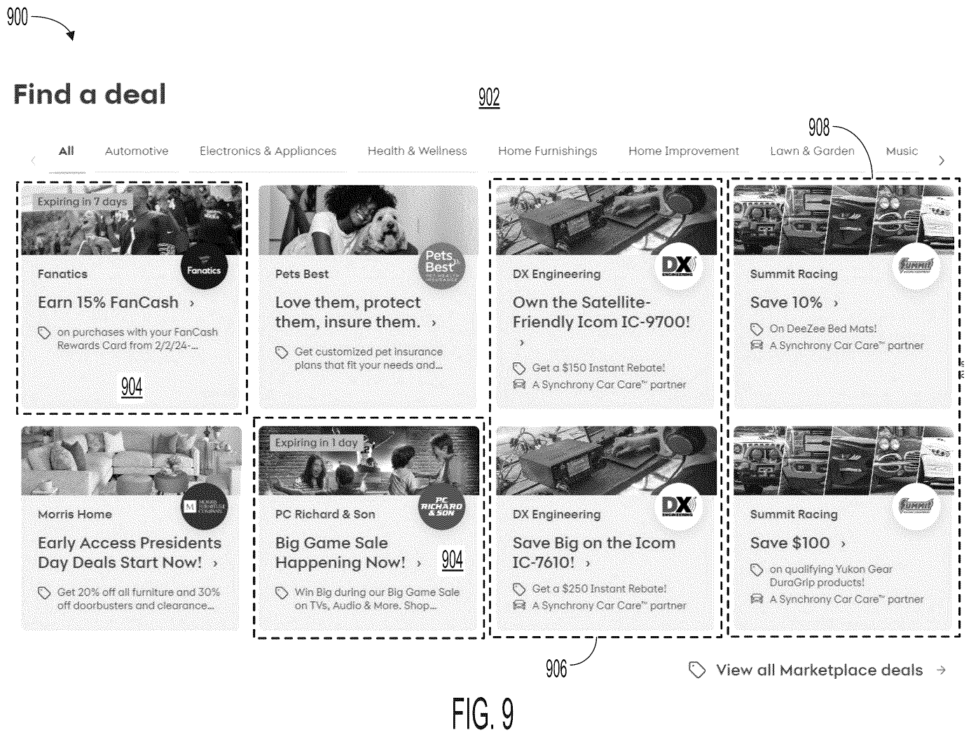

FIG. 9 shows an illustrative example of an environment 900 through which a set of offers selected based on user interaction data is categorized and presented according to a set of applicable rules in accordance with at least one embodiment. In the environment 900, the user may access a landing page 902 through which different deals (i.e., offers) may be presented to the user through an interface implemented through the landing page 902. The user may be accessing the landing page 902 during an ongoing online session with the payment instrument service. For instance, the user may navigate to the landing page 902 from the initial landing page 802 described above in connection with FIG. 8. Alternatively, the user may be accessing the landing page 902 using a URI or other network address corresponding to the landing page 902 and through a browser application or native application provided by the payment instrument service.

Similar to the process described above in connection with FIG. 8, when the user accesses the landing page 902, the browser application or native application implemented on the user's computing device may transmit an offers parameter API call through the dynamic offers API to obtain a set of offer parameters for the landing page 902. The set of offer parameters for the landing page 902 may include an indication that the offers to be presented through the interface implemented via the landing page 902 are to correspond to the “deal” type or category. Further, the set of offer parameters for the interface implemented through the landing page 902 may include an indication that up to eight offers may be presented simultaneously through this interface, which may represent a designated area of the landing page 902. These identified offer parameters may be returned to the user in response to the offers parameter API call. The user may include the provided offer parameters to the dynamic offers API through the offers API call.

As noted above, if the user is interacting with the payment instrument service for the first time (i.e., the user is accessing the landing page 902 for the first time), the offers API call may be devoid of a user identifier and of a session identifier (e.g., null values are provided for both the user and session identifiers). Alternatively, if the user is accessing the landing page 902 to resume an ongoing online session with the payment instrument service, the offers API call may include, from a browser cookie or application storage, the user identifier associated with the user and the session identifier corresponding to the ongoing online session. For instance, if the user is accessing the landing page 902 through an initial landing page (such as the landing page 802 described above in connection with FIG. 8), the browser application or native application implemented on the user's computing device may persist (in a cookie or application storage, respectively) a user identifier corresponding to the user and a session identifier corresponding to the present online session with the payment instrument service. The session identifier may be associated with user interaction data corresponding to the user's interactions during the present online session. For example, if the user is accessing the landing page 902 from the aforementioned initial landing page, the session identifier may be associated with any user interaction data corresponding to the user's interactions with the initial landing page.

As noted above, the offers generation system, using any provided identifiers (e.g., session identifier and/or user identifier) and any user characteristics/parameters associated with the user (network address associated with the user's computing device, any available location data associated with the user, computing device configurations, etc.), may obtain any available user interaction data associated with the user. For instance, if the user is accessing the landing page 902 through an initial landing page associated with the payment instrument service, the offers generation system may use the provided session identifier and user identifier to identify the user interaction data corresponding to the user's historical interactions with the payment instrument service and any user interaction data corresponding to the user's interactions with the initial landing page. If the offers request does not include both the user identifier and the session identifier, the offer generation system may automatically determine that the payment instrument service does not currently maintain any user interaction data associated with the user, as described above. In addition to obtaining any available user interaction data corresponding to the user's interactions with the payment instrument service, the offer generation system may query a user data connectivity platform or other third-party data broker to obtain any external user interaction data corresponding to user online interactions with other online assets.

The offer generation system may process the available user interaction data (both internal and external to the payment instrument service), the provided user parameters, and the offer parameters for the landing page 902 through the one or more offer selection machine learning algorithms that are dynamically trained to select a set of offers that may be presented to users. The one or more offer selection machine learning algorithms may automatically evaluate a set of available offers according to the provided user data (e.g., user interaction data and user parameters), the offer parameters for the landing page 902, and any applicable rules to select a set of offers for the user. As illustrated in FIG. 9, the landing page 902 may implement an interface that is configured to accommodate eight distinct offers through a section reserved for the presentation of these offers. Accordingly, the one or more offer selection machine learning algorithms may dynamically select a set of eight offers that may be presented to the user through this interface of the landing page 902.

In the illustrative example of FIG. 9, the one or more offer selection machine learning algorithms have determined, based on the provided user interaction data, that the user is likely a sports fan that is interested in automotive racing and engineering. Further, the one or more offer selection machine learning algorithms have determined, based on the provided user interaction data, that the user may be shopping for one or more appliances ahead of a big sporting event (e.g., TVs, sound systems, etc.). Accordingly, the offer selection system may select a set of offers 904 corresponding to the user's interest in sports, a set of offers 906 corresponding to the user's interest in engineering and technology, and a set of offers 908 corresponding to the user's interest in automotive racing. Additionally, the one or more offer selection machine learning algorithms may select these offers according to the set of applicable rules defined by the payment instrument service and/or by the brands associated with these offers. Returning to the illustrative example of FIG. 9, the one or more offer selection machine learning algorithms may select the specific set of offers 904 according to an applicable rule whereby offers set to expire within one week are to be prioritized over other similar offers. As another illustrative example, the one or more offer selection machine learning algorithms may select the set of offers 906 and 908 for a particular set of brands based on applicable rules associated with these particular brands. For instance, referring the set of offers 906, if DX Engineering has defined a rule whereby its offers are to be contractually presented a pre-defined number of times to users that are interested in engineering products, the one or more offer selection machine learning algorithms may determine whether this requirement has been satisfied and, if not, prioritize these offers 906 over other engineering-related offers.

Once the one or more offer selection machine learning algorithms have dynamically selected a set of offers for presentation to the user through the landing page 902, the one or more offer selection machine learning algorithms provide a set of identifiers or other metadata associated with the selected set of offers to the offer delivery system of the payment instrument service. The offer delivery system may use these identifiers or metadata to obtain any assets or other content usable to render the selected set of offers through the interface implemented via the landing page 902 according to any configuration requirements defined by the one or more offer selection machine learning algorithms. For instance, offers that are set to expire soon (e.g., offers 904) may be presented ahead of any other offers through the interface. Further, offers associated with a particular brand may be grouped together within the interface implemented through the landing page 902 (e.g., set of offers 906, set of offers 908). Accordingly, when the browser application or native application receives these assets or other content, the browser application or native application may dynamically use the assets or other content to render the set of offers through the interface according to these configuration requirements. This process may be performed in real-time or near real-time such that the set of offers are presented to the user nearly instantaneously when accessing the landing page 902.

As the user interacts with the set of offers 904-908 presented on the landing page 902, the payment instrument service may monitor, in real-time, these interactions to obtain any feedback that can be used to dynamically re-train or otherwise update one or more offer selection machine learning algorithms. For instance, if the user selects a particular offer from the set of offers 904-908 presented through the landing page 902 (such as through interaction with one or more interface elements associated with the particular offer), the payment instrument service may use this selection as an indication that the user has responded positively to the particular offer. As another illustrative example, if the user selects an interface option to dismiss a presented offer (e.g., the user is not interested in the presented offer, the presented offer is repetitive, the user has already taken advantage of the offer, etc.), the payment instrument service may use this action as an indication that the user has responded negatively to the particular offer. These interactions with the presented offers 904-908 may be annotated and used to update the dataset used to dynamically train the one or more offer selection machine learning algorithms. Thus, as the user navigates the landing page 902 and any other websites/landing pages associated with the payment instrument service, the user's interactions with presented offers may be used to further customize and tailor different offers that may be presented to the user through the landing page 902 and any other websites/landing pages during the present online session and any future online sessions with the payment instrument service.

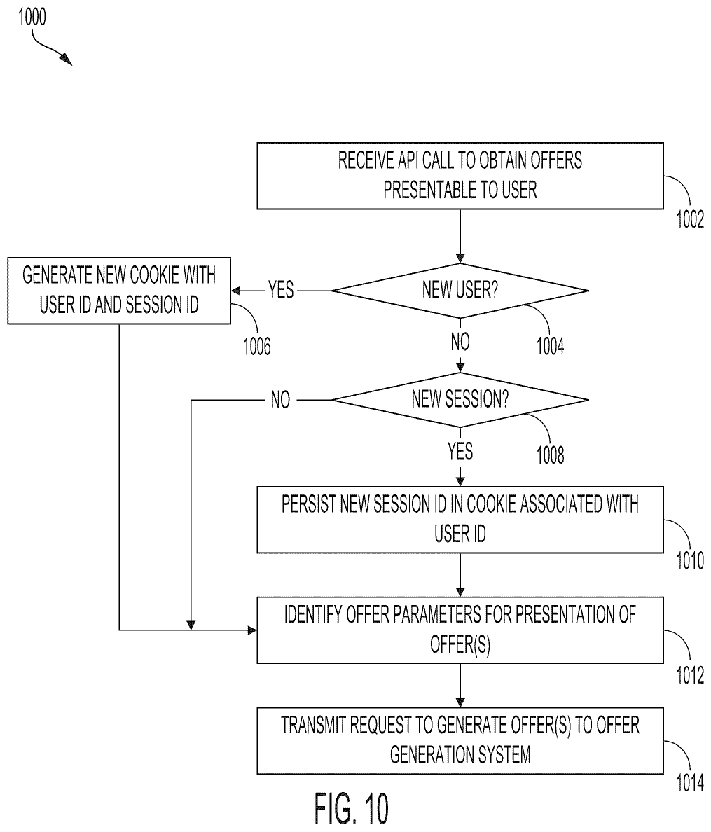

FIG. 10 shows an illustrative example of a process 1000 for identifying a set of offer parameters and submitting a request to generate a set of offers presentable to a user in response to an API call in accordance with at least one embodiment. The process 1000 may be performed by a dynamic offers API, which may process incoming API calls to obtain a set of offers that may be displayed to a user through a website or native application landing page being accessed by the user through their browser application or a native application provided by the payment instrument service, respectively.

At step 1002, the dynamic offers API may receive an API call from a user to obtain a set of offers that may be presented to the user through a website or native application landing page being accessed by the user. As noted above, the API call from the user may include identifying information associated with the user, as well as identifying information corresponding to an ongoing online session with the payment service provider. For instance, if the user has previously accessed the payment instrument service, the user (either in a cookie or application storage) may maintain a user identifier and session identifier associated with the user and corresponding to the user's interactions with the payment instrument service. If the user is accessing the payment instrument service for the first time, the offers API call from the user may be devoid of a user identifier and a session identifier, as the user has not previously interacted with the payment instrument service. Alternatively, if the user has previously interacted with the payment instrument service but is otherwise initiating a new online session with the payment instrument service, the offers API call from the user may include the user identifier stored in the cookie or application storage. However, the offers API call in this instance may be devoid of a session identifier, as the user is initiating a new online session with the payment instrument service. In some instances, if the user is resuming an online session with the payment instrument service, the offers API call may include both the user identifier and the session identifier from the cookie or application storage.

At step 1004, the dynamic offers API may evaluate the API call to determine whether the API call is associated with a new user (i.e., a user accessing the payment instrument service for the first time). As noted above, the API call from the user may include values corresponding to a user identifier and a session identifier that may be associated with the user and may correspond to user interactions with the payment instrument service. If the user is accessing the payment instrument service for the first time, the values corresponding to the user identifier and the session identifier may be null, as no identifiers may have been previously generated for the user by the payment instrument service. Accordingly, if the dynamic offers API determines that the values corresponding to the user identifier and the session identifier are null, the dynamic offers API may determine that the user is a new user accessing the payment instrument service for the first time.

If the dynamic offers API determines that the user is accessing the payment instrument service for the first time, the dynamic offers API, at step 1006 and through an offer generation system implemented by the payment instrument service, may generate a new cookie or application storage that may be used to persist a new user identifier and session identifier for the user. The dynamic offers API may further persist the new user identifier and session identifier in the browser cookie if the user is accessing a website provided by the payment instrument service through a browser application executed on their computing device. Alternatively, if the user is accessing a native application landing page implemented by the payment instrument service through a native application implemented on the user's computing device, the dynamic offers API may persist the newly generated user identifier and session identifier in application storage corresponding to the native application executed on the user's computing device and provided by the payment instrument service.

If the dynamic offers API determines, based on its evaluation of the API call, that the user is not a first-time user of the payment instrument service (e.g., the value for the user identifier is not null), the dynamic offers API, at step 1008, may determine whether the user is initiating a new session with the payment instrument service. As noted above, the API call to the dynamic offers API may include a set of fields corresponding to a user identifier associated with the user and a session identifier associated with an ongoing online session with the payment instrument service. If the user has previously accessed the payment instrument service but is initiating a new session with the payment instrument service, the API call transmitted by the user may include a user identifier associated with the user and may indicate a null value for the session identifier. Thus, to determine whether the API call corresponds to a new session with the payment instrument service, the dynamic offers API may determine whether the value for the session identifier is null.

If the dynamic offers API determines that the user is initiating a new session with the payment instrument service, the dynamic offers API, at step 1010 and through the offers generation system, may generate a new session identifier associated with this new session and may persist this new session identifier in the browser cookie if the user is accessing a website provided by the payment instrument service through a browser application executed on their computing device. Alternatively, if the user is accessing a native application landing page implemented by the payment instrument service through a native application implemented on the user's computing device, the dynamic offers API may persist the newly generated session identifier in the application storage corresponding to the native application executed on the user's computing device and provided by the payment instrument service.

At step 1012, the dynamic offers API may identify a set of offer parameters for presentation of different offers on the website or native application landing page being accessed by the user. For instance, the dynamic offers API may transmit a request to a parameter repository maintained by the payment instrument service to obtain a set of offer parameters for the particular website or native application landing page being accessed. As noted above, the parameter repository may store the available offer parameters used by the payment instrument service to categorize and organize the different offers made available by different brands and other entities for presentation through the website or other native application landing page. The available offer parameters may include the types of offers made available (e.g., financing offers, discounts, deals, etc.), the offer categories (e.g., décor, automotive, apparel, electronics, health and fitness, home furnishings, etc.), the brands or other entities associated with the payment instrument service, and the like. The available offer parameters may further include an indication of whether the payment instrument service provides its own set of offers according to any of the defined offer types and/or categories.

The available offer parameters may be defined by the payment instrument service according to the configuration of the website and any other landing pages or subsites through which different offers may be presented. For example, a website or other landing page implemented by the payment instrument service may allow for the presentation of a featured set of offers without indication of the type or category of offers being presented. Thus, the offer parameters for this website or other landing page may include the brands or other entities associated with the payment instrument service for which offers may be presented. Further, the offer parameters may further include an indication as to whether offers associated with the payment instrument service are available for presentation through this website or other landing page. As another illustrative example, if the user navigates to the online marketplace provided by the payment instrument service, and through which different offers may be presented according to different offer types, categories, and brands, the offer parameters may correspond to these different offer types, offer categories, and brands associated with the available offers presentable through the online marketplace.

At step 1014, the dynamic offers API may transmit a request to the offer generation system to generate a set of offers in response to the user's API call. As noted above, the request may include the aforementioned offer parameters for the particular website or native application landing page, as well as the user characteristics or parameters provided by the user. If the user has previously interacted with the payment instrument service, the offers request may further include the user identifier and the session identifier (if the request is submitted during an ongoing online session) associated with the user. As noted above, if the user is accessing the payment instrument service for the first time, the offer generation system may dynamically generate new user and session identifiers for the user and, through the dynamic offers API, persist the new user and session identifiers in a browser cookie or in application storage. Similarly, if the offers request includes a user identifier but is devoid of a session identifier (i.e., the user is initiating a new online session with the payment instrument service), the offer generation system may dynamically generate a new session identifier the user and, through the dynamic offers API, persist the new session identifier in the existing browser cookie or application storage. However, in generating the set of offers that may be presented to the user, the offer generation system may utilize the original values for the session and user identifiers provided in the API call.

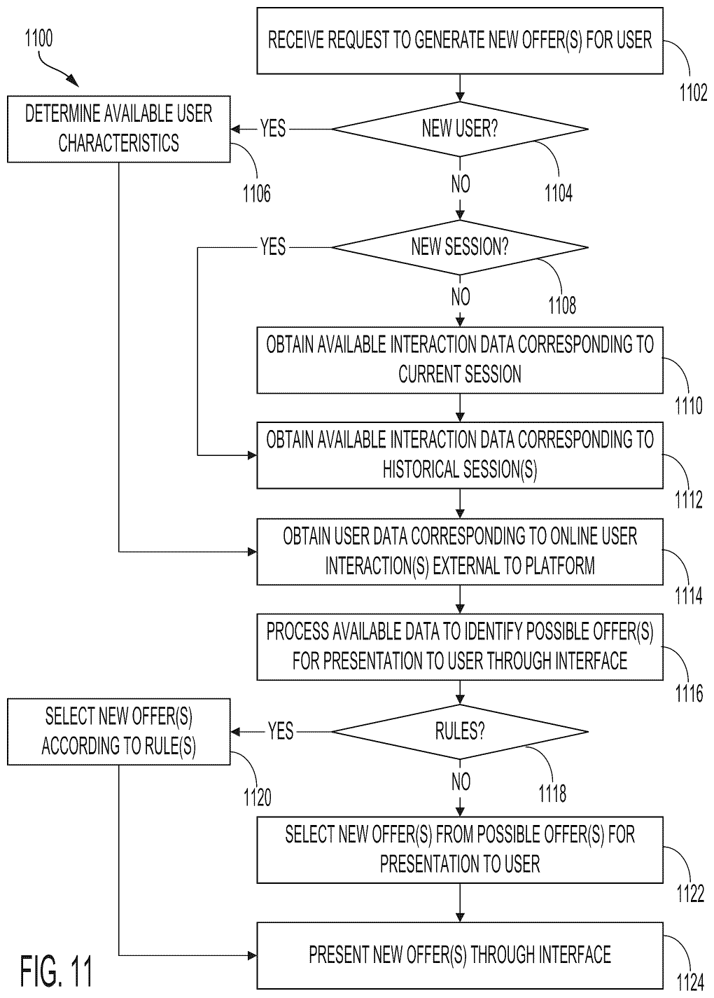

FIG. 11 shows an illustrative example of a process 1100 for selecting a set of offers based on user interaction data corresponding to user interactions on a website associated with a payment instrument service and on external websites in accordance with at least one embodiment. The process 1100 may be performed by the aforementioned offer generation system. As noted above, the offer generation system may implement and dynamically train one or more offer selection machine learning algorithms that can process any available user interaction data associated with a user, the offer parameters corresponding to the website or native application landing page being accessed, and any applicable offer rules to select a set of offers that may be presented to the user through the website or native application landing page. Thus, certain operations of the process 1100 may be performed automatically by the one or more offer selection machine learning algorithms based on these provided inputs.

At step 1102, the offer generation system may receive a request to generate a new set of offers that may be presented to a user through a website or native application landing page being accessed by the user. As noted above, this request may be received from a dynamic offers API and may include values corresponding to a user identifier associated with the user and a session identifier corresponding to an ongoing session with the payment instrument service. As noted above, if the user is accessing the payment instrument service for the first time, the user and session identifiers associated with the user may be null. Alternatively, if the user is resuming an online session with the payment instrument service (e.g., accessing a new website or landing page through another website or landing page implemented by the payment instrument service, etc.), the request may include unique values for the user identifier and the session identifier. If the user has previously accessed the payment instrument service but is otherwise initiating a new online session with the payment instrument service, the session identifier may be null. The request may further include the set of offer parameters applicable to the website or native application landing page being accessed, as well as other characteristics or parameters associated with the user (e.g., the network address associated with the user's computing device, any available location data associated with the user, computing device configurations, etc.).

At step 1104, the offer generation system may evaluate the request to determine whether the user is accessing the payment instrument service for the first time (e.g., the user is a new user to the payment instrument service). For instance, the offer generation system may evaluate the value corresponding to the user identifier provided in the request to determine whether this value is null. If the value corresponding to the user identifier is null, the offer generation system may determine that the user is a new user to the payment instrument service. Accordingly, at step 1106, the offer generation system may determine any available user characteristics that may be used to identify any user interaction data from external sources and associated with the user. For instance, if the request includes a set of user characteristics or parameters, as described above, the offer generation system may extract this set of user characteristics or parameters from the request. In some examples, if the request is devoid of any user characteristics or parameters, the offer generation system may evaluate the request itself to identify any user characteristics or parameters. For example, through the API call, the offer generation system may determine the IP address or other network address of the user, an estimated location of the user (such as through IP geolocation, etc.), and the like.

If the offer generation system determines that the user has previously accessed the payment instrument service (e.g., the value corresponding to the user identifier is not null), the offer generation system may determine, at step 1108, whether the user is initiating a new online session with the payment instrument service. As noted above, the API call to the dynamic offers API may include a set of fields corresponding to a user identifier associated with the user and a session identifier associated with an ongoing online session with the payment instrument service. If the user has previously accessed the payment instrument service but is initiating a new session with the payment instrument service, the API call transmitted by the user may include a user identifier associated with the user and may indicate a null value for the session identifier. Thus, to determine whether the request corresponds to a new session with the payment instrument service, the offer generation system may determine whether the value for the session identifier provided through the offers API call is null.

If the offer generation system determines that a session identifier has been provided in the request (i.e., the value corresponding to the session identifier is not a null value), the offer generation system, at step 1110, may obtain any user interaction data corresponding to the current online session with the payment instrument service. As noted above, the user interaction data maintained by the payment instrument service for each user may be delineated according to when the user interaction data was collected. For instance, the offer generation system may distinguish user interaction data collected during a current, ongoing session with the payment instrument service from other historical user interaction data collected during prior sessions with the payment instrument service. Thus, if the request to generate new offers for the user includes a session identifier, the offer generation system may use this session identifier to identify any user interaction data that is specific to the ongoing online session between the user and the payment instrument service. Additionally, or alternatively, the offer generation system, at step 1112, may further obtain any user interaction data corresponding to the user's previous or historical online sessions with the payment instrument service. This historical user interaction data may be obtained by the offer generation system using the provided user identifier.

At step 1114, regardless of whether the user is accessing the payment instrument service for the first time (e.g., null values are provided for the user and session identifiers) or has previously accessed the payment instrument service (e.g., the session identifier and/or user identifier are provided in the request), the offer generation system may obtain any available user interaction data corresponding to the user's interactions with any external assets (e.g., websites not associated with the payment instrument service, applications not associated with the payment instrument service, electronic mail services, social media platforms, etc.). As noted above, the offer generation system may query a user data connectivity platform or other third-party data broker to obtain any external user interaction data associated with the user and corresponding to any external online interactions by the user with these external assets. This user interaction data may be obtained through cookies or application storage implemented on the user's computing device and associated with the different online assets that the user may interact with. The user data connectivity platform or other third-party data broker may generate, for each user, a unique identifier that may be used to deterministically associate the user with any user interaction data across these different online platforms and assets. This unique identifier generated by the user data connectivity platform or other third-party data broker may be associated with different user information that may be known to the payment instrument service (e.g., PII, name, physical address, network address, telephone number(s), etc.). The offer generation system may implement a translation layer through which the offer generation system can query the user data connectivity platform or other third-party data broker for any available user interaction data using any available user information that may be known to both the payment instrument service and the user data connectivity platform or other third-party data broker. Using this known user information, the offer generation system may query the user data connectivity platform or other third-party data broker to obtain any available user interaction data associated with the user. If the user is accessing the payment instrument service for the first time, the offer generation system 108 may use the user characteristics or parameters provided in the request to query the user data connectivity platform or other third-party data broker.

At step 1116, the offer generation system, through one or more offer selection machine learning algorithms (such as the one or more offer selection machine learning algorithms 206 described above in connection with FIGS. 2-3), may process the obtained user interaction data, available offers, and any offer parameters corresponding to the website or native application landing page being accessed to identify an initial set of offers that may be presented to the user through the website or native application landing page. As noted above, the one or more offer selection machine learning algorithms are dynamically trained in real-time to process available user interaction data and/or user parameters, as well as the set of available offers corresponding to the defined offer parameters and any applicable rules, to identify different offers that may be presented to users. The one or more offer selection machine learning algorithms may process the user interaction data from the user data connectivity platform or other third-party data broker and any user interaction data maintained by the payment instrument service (e.g., data corresponding to user interactions with websites, native application landing pages or interfaces implemented by the payment instrument service, etc.), as well as the set of available offers and the offer parameters to identify the initial set of offers that may be presented to the user through the website or native application landing page.

At step 1118, the offer generation system may determine whether there are any applicable rules that may be used to refine the initial set of offers to select a final set of offers that may be presented to the user through the website or native application landing page. For instance, the offer generation system may obtain any rules that may be applicable towards the selection of a set of offers from the available offers maintained by the payment instrument service. As noted above, the payment instrument service, through an offer repository, may store offer-specific rules defined by the payment instrument service and/or the corresponding brand/other entity for determining the methods in which corresponding offers may be presented to users. For example, offer-specific rules may indicate the number of times that particular offers are required to be presented within a period of time to users through a website or native application implemented by the payment instrument service. As another illustrative example, offer-specific rules may indicate whether the corresponding offers are to be prioritized according to their expiration date. In another illustrative example, an offer-specific rule may indicate that an offer may only be presented on particular websites/native application landing pages. The offer repository may further maintain a set of global offer rules that may be applicable to all offers made available through the offer repository.

If the offer generation system determines that there are a set of rules that are applicable to the initial set of offers selected by the one or more offer selection machine learning algorithms, the offer generation system, at step 1120, may process these rules through the one or more offer selection machine learning algorithms to cause the one or more offer selection machine learning algorithms to select the final set of offers according to these applicable rules. Alternatively, if the offer generation system determines that there are no applicable rules, the offer generation system, at step 1122, may use the initial set of offers selected by the one or more offer selection machine learning algorithms for presentation to the user.

At step 1124, the offer generation system may present these selected offers to the user through the website or native application landing page being accessed. For instance, as noted above, the offer generation system may provide, to an offer delivery system implemented by the payment instrument service, a set of identifiers or metadata corresponding to the offers selected for presentation to the user through the website or native application landing page. In response to receiving this set of identifiers or metadata corresponding to the selected offers, the offer delivery system may obtain any content or other assets associated with the selected offers (e.g., HTML code, CSS, JavaScript code, applets, images, videos, text, etc.) that may be used to render the offers through the website and/or native application landing page being accessed by the user. Once the offer delivery system has obtained the requisite content or other assets corresponding to the selected offers, the offer delivery system may transmit this content or other assets to the user's computing device for rendering of the selected offers through the browser application or native application implemented on the user's computing device. The content or other assets may include executable instructions that, when executed by the browser application or native application, may cause the browser application or native application to render these offers according to the pre-defined offer locations on the website or native application landing page, respectively.

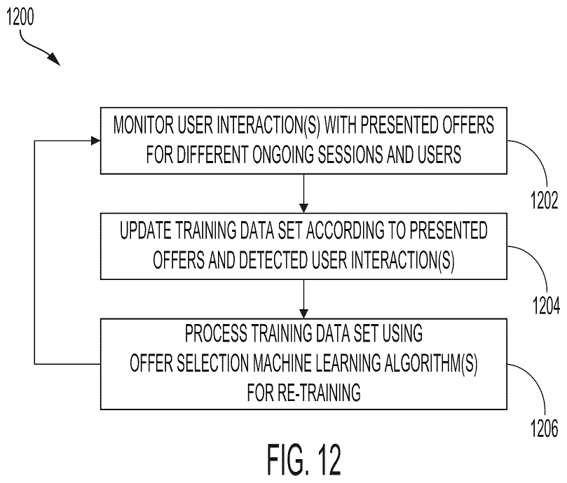

FIG. 12 shows an illustrative example of a process 1200 for monitoring user interactions with a presented set of offers to obtain feedback for updating one or more offer selection machine learning algorithms in accordance with at least one embodiment. The process 1200 may be performed by the aforementioned offer generation system, which may continuously monitor user interactions with the myriad websites and/or native application landing pages implemented by the payment instrument service to detect any user interactions with presented offers.

At step 1202, the offer generation system may monitor, in real-time, any user interactions with different offers presented through different websites and/or native application landing pages implemented by the payment instrument service and corresponding to different users. As noted above, the offer generation system may monitor, in real-time, any user interactions with the selected offers to obtain any feedback that can be used to dynamically re-train the one or more offer selection machine learning algorithms implemented by the offer generation system for selecting offers presentable to different users. For instance, if a user selects a particular offer from those presented through a website or native application landing page, the offer generation system may use this selection as an indication that the user has responded positively to the particular offer. As another illustrative example, if the user selects an option to dismiss a presented offer (e.g., the user is not interested in the presented offer, the presented offer is repetitive, the user has already taken advantage of the offer, etc.), the offer generation system may use this action as an indication that the user has responded negatively to the particular offer. These interactions with the presented offers may be annotated by the offer generation system. It should be noted that this monitoring of user interactions with the presented offers may be performed continuously and simultaneously for different websites and/or native application landing pages as different users interact with these different websites and/or native application landing pages and the myriad offers presented therein. Further, as the offers presented to these different users may be unique to each user based on their available user interaction data, the annotations corresponding to these interactions may indicate which user is associated with each interaction, which offer(s) were presented to each user through the corresponding website/native application landing page, and the response of the user to these offer(s). Since many users may be simultaneously accessing the payment instrument service through different websites and native application landing pages at the same time, this monitoring and annotation of user interactions is performed in real-time or near real-time and could not be performed through the human mind.

At step 1204, the offer generation system dynamically, and in real-time or near real-time, updates the training dataset according to the offers presented to these different users and the corresponding user interactions with these offers. For instance, the offer generation system may generate, using the aforementioned annotations, new data points that may be added to the dataset to expand the breadth of the dataset. Since the aforementioned annotations are generated in real-time as different users interact with different offers presented through the different websites/native application landing pages implemented by the payment instrument service, the updating of the dataset used to train the one or more offer selection machine learning algorithms may also be performed in real-time.

At step 1206, the offer generation system may process the updated training dataset through the one or more offer selection machine learning algorithms to re-train the one or more offer selection machine learning algorithms. Returning to an earlier example, if a user selects a particular offer from those presented through the website or native application landing page, the offer generation system may use this selection as an indication that the user has responded positively to the particular offer. Accordingly, the offer generation system may annotate this particular offer to indicate that the user responded positively to the offer and may update the dataset to include this annotation. Processing of the updated dataset may result in reinforcement of the one or more offer selection machine learning algorithms such that, for similar users and user interaction data, the likelihood of this offer being selected may be maintained or increased. Alternatively, if the user selects an option to dismiss a selected offer (e.g., the user is not interested in the selected offer, the selected offer is repetitive, the user has already taken advantage of the selected offer, etc.), the offer generation system may use this action as an indication that the user has responded negatively to the selected offer. The offer generation system may annotate this particular offer to indicate that the user responded negatively to the offer and may update the dataset to include this annotation. Processing of the updated dataset may result in re-training of the one or more offer selection machine learning algorithms such that, for similar users and user interaction data, the likelihood of this offer being selected may be reduced.

As noted above, the real-time monitoring of user interactions with selected offers may be performed for different users accessing the website or native application landing page simultaneously and continuously as these different users interact with the different offers selected for them. This simultaneous and continuous monitoring of interactions with the selected offers presented to different users may allow for dynamic updating of the dataset used to train the one or more offer selection machine learning algorithms. Thus, the one or more offer selection machine learning algorithms may be dynamically updated in real-time as different users interact with the different offers selected by the one or more offer selection machine learning algorithms for these different users. This may allow for continuous improvement in the accuracy of the one or more offer selection machine learning algorithms in selecting different offers according to each user's unique characteristics and interaction data.

FIG. 13 illustrates a computing system architecture 1300, including various components in electrical communication with each other, in accordance with some embodiments. The example computing system architecture 1300 illustrated in FIG. 13 includes a computing device 1302, which has various components in electrical communication with each other using a connection 1306, such as a bus, in accordance with some implementations. The example computing system architecture 1300 includes a processing unit 1304 that is in electrical communication with various system components, using the connection 1306, and including the system memory 1314. In some embodiments, the system memory 1314 includes read-only memory (ROM), random-access memory (RAM), and other such memory technologies including, but not limited to, those described herein. In some embodiments, the example computing system architecture 1300 includes a cache 1308 of high-speed memory connected directly with, in close proximity to, or integrated as part of the processor 1304. The system architecture 1300 can copy data from the memory 1314 and/or the storage device 1310 to the cache 1308 for quick access by the processor 1304. In this way, the cache 1308 can provide a performance boost that decreases or eliminates processor delays in the processor 1304 due to waiting for data. Using modules, methods and services such as those described herein, the processor 1304 can be configured to perform various actions. In some embodiments, the cache 1308 may include multiple types of cache including, for example, level one (L1) and level two (L2) cache. The memory 1314 may be referred to herein as system memory or computer system memory. The memory 1314 may include, at various times, elements of an operating system, one or more applications, data associated with the operating system or the one or more applications, or other such data associated with the computing device 1302.

Other system memory 1314 can be available for use as well. The memory 1314 can include multiple different types of memory with different performance characteristics. The processor 1304 can include any general purpose processor and one or more hardware or software services, such as service 1312 stored in storage device 1310, configured to control the processor 1304 as well as a special-purpose processor where software instructions are incorporated into the actual processor design. The processor 1304 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1304 can be a microprocessor, a microcontroller, a digital signal processor (“DSP”), or a combination of these and/or other types of processors. In some embodiments, the processor 1304 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1300, an input device 1316 can represent any number of input mechanisms, such as a microphone for speech, a touch-sensitive screen for gesture or graphical input, keyboard, mouse, motion input, pen, and other such input devices. An output device 1318 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1300. In some embodiments, the input device 1316 and/or the output device 1318 can be coupled to the computing device 1302 using a remote connection device such as, for example, a communication interface such as the network interface 1320 described herein. In such embodiments, the communication interface can govern and manage the input and output received from the attached input device 1316 and/or output device 1318. As may be contemplated, there is no restriction on operating on any particular hardware arrangement and accordingly the basic features here may easily be substituted for other hardware, software, or firmware arrangements as they are developed.

In some embodiments, the storage device 1310 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described herein, the storage device 1310 can include hardware and/or software services such as service 1312 that can control or configure the processor 1304 to perform one or more functions including, but not limited to, the methods, processes, functions, systems, and services described herein in various embodiments. In some embodiments, the hardware or software services can be implemented as modules. As illustrated in example computing system architecture 1300, the storage device 1310 can be connected to other parts of the computing device 1302 using the system connection 1306. In an embodiment, a hardware service or hardware module such as service 1312, that performs a function can include a software component stored in a non-transitory computer-readable medium that, in connection with the necessary hardware components, such as the processor 1304, connection 1306, cache 1308, storage device 1310, memory 1314, input device 1316, output device 1318, and so forth, can carry out the functions such as those described herein.

The disclosed payment instrument service, the sub-systems and other processes of the payment instrument service, and the systems and methods for dynamically, and in real-time, selecting offers that may be presented to users according to any user interaction data associated with these users can be performed using a computing system such as the example computing system illustrated in FIG. 13, using one or more components of the example computing system architecture 1300. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for dynamically, and in real-time, selecting offers that may be presented to users according to any user interaction data associated with these users described herein by, for example, executing code using a processor such as processor 1304 wherein the code is stored in memory such as memory 1314 as described herein. One or more of a user device, a provider server or system, a database system, or other such devices, services, or systems may include some or all of the components of the computing system such as the example computing system illustrated in FIG. 13, using one or more components of the example computing system architecture 1300 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1328. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1304 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 1314 can be coupled to the processor 1304 by, for example, a connector such as connector 1306, or a bus. As used herein, a connector or bus such as connector 1306 is a communications system that transfers data between components within the computing device 1302 and may, in some embodiments, be used to transfer data between computing devices. The connector 1306 can be a data bus, a memory bus, a system bus, or other such data transfer mechanism. Examples of such connectors include, but are not limited to, an industry standard architecture (ISA” bus, an extended ISA (EISA) bus, a parallel AT attachment (PATA” bus (e.g., an integrated drive electronics (IDE) or an extended IDE (EIDE) bus), or the various types of parallel component interconnect (PCI) buses (e.g., PCI, PCIe, PCI-104, etc.).

The memory 1314 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 1314 can also include magnetic or optical data storage media including read-only (e.g., CD ROM and DVD ROM) or otherwise (e.g., CD or DVD). The memory can be local, remote, or distributed.

As described herein, the connector 1306 (or bus) can also couple the processor 1304 to the storage device 1310, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1310. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1306 can also couple the processor 1304 to a network interface device such as the network interface 1320. The interface can include one or more of a modem or other such network interfaces including, but not limited to those described herein. It will be appreciated that the network interface 1320 may be considered to be part of the computing device 1302 or may be separate from the computing device 1302. The network interface 1320 can include one or more of an analog modem, Integrated Services Digital Network (ISDN) modem, cable modem, token ring interface, satellite transmission interface, or other interfaces for coupling a computer system to other computer systems. In some embodiments, the network interface 1320 can include one or more input and/or output (I/O) devices. The I/O devices can include, by way of example but not limitation, input devices such as input device 1316 and/or output devices such as output device 1318. For example, the network interface 1320 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™ SunOS™, HP-UX®, etc.), mobile operating systems (e.g., iOS® and variants, Chrome®, Ubuntu Touch®, watchOS®, Windows 10 Mobile®, the Blackberry®OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 1302 can be connected to one or more additional computing devices such as computing device 1324 via a network 1322 using a connection such as the network interface 1320. In such embodiments, the computing device 1324 may execute one or more services 1326 to perform one or more functions under the control of, or on behalf of, programs and/or services operating on computing device 1302. In some embodiments, a computing device such as computing device 1324 may include one or more of the types of components as described in connection with computing device 1302 including, but not limited to, a processor such as processor 1304, a connection such as connection 1306, a cache such as cache 1308, a storage device such as storage device 1310, memory such as memory 1314, an input device such as input device 1316, and an output device such as output device 1318. In such embodiments, the computing device 1324 can carry out the functions such as those described herein in connection with computing device 1302. In some embodiments, the computing device 1302 can be connected to a plurality of computing devices such as computing device 1324, each of which may also be connected to a plurality of computing devices such as computing device 1324. Such an embodiment may be referred to herein as a distributed computing environment.

The network 1322 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 1322 can be wired connections, wireless connections, or combinations thereof. Communications via the network 1322 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 1322, within the computing device 1302, within the computing device 1324, or within the computing resources provider 1328 can include information, which also may be referred to herein as content. The information may include text, graphics, audio, video, haptics, and/or any other information that can be provided to a user of the computing device such as the computing device 1302. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 1302 and presented to a user of the computing device 1302 using forms that are perceptible via sight, sound, smell, taste, touch, or other such mechanisms. In some embodiments, communications over the network 1322 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 1302 and/or the computing device 1324 can be connected to a computing resources provider 1328 via the network 1322 using a network interface such as those described herein (e.g. network interface 1320). In such embodiments, one or more systems (e.g., service 1330 and service 1332) hosted within the computing resources provider 1328 (also referred to herein as within “a computing resources provider environment”) may execute one or more services to perform one or more functions under the control of, or on behalf of, programs and/or services operating on computing device 1302 and/or computing device 1324. Systems such as service 1330 and service 1332 may include one or more computing devices such as those described herein to execute computer code to perform the one or more functions under the control of, or on behalf of, programs and/or services operating on computing device 1302 and/or computing device 1324.

For example, the computing resources provider 1328 may provide a service, operating on service 1330 to store data for the computing device 1302 when, for example, the amount of data that the computing device 1302 exceeds the capacity of storage device 1310. In another example, the computing resources provider 1328 may provide a service to first instantiate a virtual machine (VM) on service 1332, use that VM to access the data stored on service 1332, perform one or more operations on that data, and provide a result of those one or more operations to the computing device 1302. Such operations (e.g., data storage and VM instantiation) may be referred to herein as operating “in the cloud,” “within a cloud computing environment,” or “within a hosted virtual machine environment,” and the computing resources provider 1328 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 1328 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 1330 and service 1332 may implement versions of various services (e.g., the service 1312 or the service 1326) on behalf of, or under the control of, computing device 1302 and/or computing device 1324. Such implemented versions of various services may involve one or more virtualization techniques so that, for example, it may appear to a user of computing device 1302 that the service 1312 is executing on the computing device 1302 when the service is executing on, for example, service 1330. As may also be contemplated, the various services operating within the computing resources provider 1328 environment may be distributed among various systems within the environment as well as partially distributed onto computing device 1324 and/or computing device 1302.

In an embodiment, the computing device 1302 can be connected to one or more additional computing devices and/or services such as merchant computing device 1336 and/or a point-of-sale service 1334 via the network 1322 and using a connection such as the network interface 1320. In an embodiment, the point-of-sale service 1334 is separate from the merchant computing device 1336. In an embodiment, the point-of-sale service 1334 is executing on the merchant computing device 1336. In an embodiment, the point-of-sale service 1334 is executing as one or more services (e.g., the service 1330 and/or the service 1332) operating within the environment of the computing resources provider. As used herein, a point-of-sale service 1334 is a service used by one or more merchants to manage sales transactions for customers, to process payment transactions for customers (e.g., payment instrument transactions), to manage inventory for merchants, to identify customers based on, for example, customer loyalty programs, and other such tasks.

In an embodiment, a customer and/or a merchant uses the merchant computing device 1336 to interact with the point-of-sale service 1334. In an embodiment, the merchant computing device 1336 is a dedicated point-of-service (POS) terminal. In an embodiment, the merchant computing device 1336 is a cash register system. In an embodiment, the merchant computing device 1336 is an application or web service operating on a computing device such as the computing device 1302 described herein. In such an embodiment, the application or web service may be provided by a financial services system (e.g., a bank, a transaction processing system, an inventory management system, or some other such financial services system). In an embodiment, the merchant computing device 1336 includes an auxiliary device or system to execute tasks associated with the point-of-sale service 1334 (e.g., a payment instrument processing device attached to a smart phone or tablet). In an embodiment, the merchant computing device 1336 is a kiosk that is located at a merchant location (e.g., in a merchant's “brick and mortar” store), in a high traffic area (e.g., in a mall or in an airport concourse), or at some other such location. In such an embodiment, the kiosk may include additional branding elements to allow associating the kiosk with a vendor. In an embodiment, the merchant computing device 1336 is a virtual device (e.g., a virtual kiosk) such as the virtual devices described herein. Although not illustrated here, in an embodiment, the merchant computing device 1336 may be one of a plurality of devices that may be interconnected using a network such as the network 1322.

In an embodiment, the computing device 1302 can be connected to one or more additional computing devices and/or services such as a payment instrument service 1338 via the network 1322 and using a connection such as the network interface 1320. In an embodiment, the payment instrument service 1338 connects directly with the point of sale service 1334. In an embodiment, elements of the payment instrument service 1338 are executing on the merchant computing device 1336. In an embodiment, the payment instrument service 1338 is executing as one or more services (e.g., the service 1330 and/or the service 1332) operating within the environment of the computing resources provider. As used herein, a payment instrument service 1338 is a service used by various entities (e.g., merchants, financial institutions, and account holders) to manage payment instrument transactions (e.g., sales and payments), process payment, to issue payment instruments to account holders, and to perform other such actions.

In an embodiment, elements of the payment instrument service 1338 are running as an application or web service operating on a computing device such as the computing device 1302 described herein. In such an embodiment, the application or web service of the payment instrument service 1338 may be provided by a financial services system (e.g., a bank, a transaction processing system, an inventory management system, or some other such financial services system). In an embodiment, elements of the payment instrument service 1338 are running on an auxiliary device or system configured to execute tasks associated with the payment instrument service 1338 (e.g., uses a payment instrument processing device attached to a smart phone or tablet). In an embodiment, elements of the payment instrument service 1338 are running on virtual device such as those described herein. Although not illustrated here, in an embodiment, the payment instrument service 1338 may be running on one or more of a plurality of devices that may be interconnected using a network such as the network 1322.

In an embodiment, the computing device 1302 can be connected to one or more additional computing devices and/or services such as an authentication service 1340 via the network 1322 and using a connection such as the network interface 1320. In an embodiment, the authentication service 1340 is an element of the payment instrument service 1338. In an embodiment, the authentication service 1340 is separate from the payment instrument service 1338. In an embodiment, the authentication service 1340 connects directly with the point of sale service 1334. In an embodiment, elements of the authentication service 1340 are executing on the merchant computing device 1336. In an embodiment, the authentication service 1340 is executing as one or more services (e.g., the service 1330 and/or the service 1332) operating within the environment of the computing resources provider. As used herein, an authentication service 1340 is a service used by one or more merchants to authenticate transactions associated with payment instruments. An authentication service may be a third-party service that provides secure and verified authorization of the transactions.

In an embodiment, elements of the authentication service 1340 are running as an application or web service operating on a computing device such as the computing device 1302 described herein. In such an embodiment, the application or web service of the authentication service 1340 may be provided by a financial services system (e.g., a bank, a transaction processing system, an inventory management system, or some other such financial services system). In an embodiment, elements of the authentication service 1340 are running on an auxiliary device or system configured to execute tasks associated with the authentication service 1340 (e.g., provides authentication using payment instrument processing device attached to a smart phone or tablet). In an embodiment, elements of the authentication service 1340 are running on virtual device such as those described herein. Although not illustrated here, in an embodiment, the authentication service 1340 may be running on one or more of a plurality of devices that may be interconnected using a network such as the network 1322.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 1302) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described herein. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram. Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 1302.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described herein. The elements and acts of the various examples described herein can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described herein to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described herein may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use.

What is claimed is:

1. A computer-implemented method, comprising:
receiving an application programming interface (API) call to identify one or more offers for rendering through an interface implemented through a landing page associated with a payment instrument service, wherein the API call includes identifying information associated with a user and with an ongoing online session, and wherein the API call is submitted during a request to access the landing page;
obtaining user interaction data corresponding to interactions with different external online assets by the user, wherein the user interaction data is obtained using the identifying information;
identifying a set of available offers, wherein the set of available offers corresponds to different entities associated with the payment instrument service;
processing the user interaction data and the set of available offers through a machine learning algorithm to automatically select a set of offers from the set of available offers, wherein the machine learning algorithm is trained using a dataset of historical user interaction data and corresponding offers presented to different users through the interface;
transmitting executable instructions that, as a result of being executed by a computing device of the user, cause the computing device to render the set of offers through the interface;
monitoring in real-time and through the interface user interaction with the set of offers; and
updating the machine learning algorithm according to the user interaction with the set of offers.

2. The computer-implemented method of claim 1, wherein identifying the set of offers further comprises:
identifying a set of rules corresponding to the set of available offers, wherein the set of rules defines different requirements for rendering of different offers from the set of available offers; and
processing the set of rules with the user interaction data and the set of available offers through the machine learning algorithm to identify the set of offers.

3. The computer-implemented method of claim 1, wherein the identifying information is obtained from a cookie stored on a browser application implemented on the computing device.

4. The computer-implemented method of claim 1, wherein the identifying information includes a user identifier associated with the user and a session identifier corresponding to the ongoing online session, and wherein the user interaction data is obtained using the user identifier and the session identifier.

5. The computer-implemented method of claim 1, further comprising:
determining that the identifying information does not include a user identifier; and
generating a cookie that encodes a new user identifier associated with the user, wherein the cookie is used to track ongoing user interactions with the interface and the set of offers.

6. The computer-implemented method of claim 1, wherein the set of offers is categorized according to a set of offer parameters, and wherein the set of offers is rendered through the interface according to the set of offer parameters.

7. The computer-implemented method of claim 1, wherein obtaining the user interaction data further comprises:
translating the identifying information into an external user identifier associated with the user, wherein the external user identifier corresponds to a user data connectivity platform that obtains the user interaction data from different external sources; and
transmitting a query to obtain the user interaction data, wherein the query includes the external user identifier, and wherein when the query is received by the user data connectivity platform, the user data connectivity platform provides the user interaction data.

8. A system, comprising:
one or more processors; and
memory storing thereon instructions that, as a result of being executed by the one or more processors, cause the system to:
receive an application programming interface (API) call to identify one or more offers for rendering through an interface implemented through a landing page associated with a payment instrument service, wherein the API call includes identifying information associated with a user and with an ongoing online session, and wherein the API call is submitted during a request to access the landing page;
obtain user interaction data corresponding to interactions with different external online assets by the user, wherein the user interaction data is obtained using the identifying information;
identify a set of available offers, wherein the set of available offers corresponds to different entities associated with the payment instrument service;
process the user interaction data and the set of available offers through a machine learning algorithm to automatically select a set of offers from the set of available offers, wherein the machine learning algorithm is trained using a dataset of historical user interaction data and corresponding offers presented to different users through the interface;
transmit executable instructions that, as a result of being executed by a computing device of the user, cause the computing device to render the set of offers through the interface;
monitor in real-time and through the interface user interaction with the set of offers; and
update the machine learning algorithm according to the user interaction with the set of offers.

9. The system of claim 8, wherein the instructions that cause the system to identify the set of offers further cause the system to:
identify a set of rules corresponding to the set of available offers, wherein the set of rules defines different requirements for rendering of different offers from the set of available offers; and
process the set of rules with the user interaction data and the set of available offers through the machine learning algorithm to identify the set of offers.

10. The system of claim 8, wherein the identifying information is obtained from a cookie stored on a browser application implemented on the computing device.

11. The system of claim 8, wherein the identifying information includes a user identifier associated with the user and a session identifier corresponding to the ongoing online session, and wherein the user interaction data is obtained using the user identifier and the session identifier.

12. The system of claim 8, wherein the instructions further cause the system to:
determine that the identifying information does not include a user identifier; and
generate a cookie that encodes a new user identifier associated with the user, wherein the cookie is used to track ongoing user interactions with the interface and the set of offers.

13. The system of claim 8, wherein the set of offers is categorized according to a set of offer parameters, and wherein the set of offers is rendered through the interface according to the set of offer parameters.

14. The system of claim 8, wherein the instructions that cause the system to obtain the user interaction data further cause the system to:
translate the identifying information into an external user identifier associated with the user, wherein the external user identifier corresponds to a user data connectivity platform that obtains the user interaction data from different external sources; and
transmit a query to obtain the user interaction data, wherein the query includes the external user identifier, and wherein when the query is received by the user data connectivity platform, the user data connectivity platform provides the user interaction data.

15. A non-transitory, computer-readable storage medium storing thereon executable instructions that, as a result of being executed by one or more processors of a computer system, cause the computer system to:
receive an application programming interface (API) call to identify one or more offers for rendering through an interface implemented through a landing page associated with a payment instrument service, wherein the API call includes identifying information associated with a user and with an ongoing online session, and wherein the API call is submitted during a request to access the landing page;
obtain user interaction data corresponding to interactions with different external online assets by the user, wherein the user interaction data is obtained using the identifying information;
identify a set of available offers, wherein the set of available offers corresponds to different entities associated with the payment instrument service;
process the user interaction data and the set of available offers through a machine learning algorithm to automatically select a set of offers from the set of available offers, wherein the machine learning algorithm is trained using a dataset of historical user interaction data and corresponding offers presented to different users through the interface;
transmit rendering executable instructions that, as a result of being executed by a user computing device of the user, cause the user computing device to render the set of offers through the interface;
monitor in real-time and through the interface user interaction with the set of offers; and
update the machine learning algorithm according to the user interaction with the set of offers.

16. The non-transitory, computer-readable storage medium of claim 15, wherein the executable instructions that cause the computer system to identify the set of offers further cause the computer system to:
identify a set of rules corresponding to the set of available offers, wherein the set of rules defines different requirements for rendering of different offers from the set of available offers; and
process the set of rules with the user interaction data and the set of available offers through the machine learning algorithm to identify the set of offers.

17. The non-transitory, computer-readable storage medium of claim 15, wherein the identifying information is obtained from a cookie stored on a browser application implemented on the user computing device.

18. The non-transitory, computer-readable storage medium of claim 15, wherein the identifying information includes a user identifier associated with the user and a session identifier corresponding to the ongoing online session, and wherein the user interaction data is obtained using the user identifier and the session identifier.

19. The non-transitory, computer-readable storage medium of claim 15, wherein the executable instructions further cause the computer system to:
determine that the identifying information does not include a user identifier; and
generate a cookie that encodes a new user identifier associated with the user, wherein the cookie is used to track ongoing user interactions with the interface and the set of offers.

20. The non-transitory, computer-readable storage medium of claim 15, wherein the set of offers is categorized according to a set of offer parameters, and wherein the set of offers is rendered through the interface according to the set of offer parameters.

21. The non-transitory, computer-readable storage medium of claim 15, wherein the executable instructions that cause the computer system to obtain the user interaction data further cause the computer system to:
translate the identifying information into an external user identifier associated with the user, wherein the external user identifier corresponds to a user data connectivity platform that obtains the user interaction data from different external sources; and
transmit a query to obtain the user interaction data, wherein the query includes the external user identifier, and wherein when the query is received by the user data connectivity platform, the user data connectivity platform provides the user interaction data.
